(19) United States
(12) Patent Application Publication
(10) Pub. No.: US 2002/0027636 A1
(43) Pub. Date: Mar. 7, 2002

(54) Non-flat liquid crystal display element and method of producing the same

(76) Inventor: Jun Yamada, Takatsuki-shi (JP)

Correspondence Address: SIDLEY AUSTIN BROWN & WOOD, 717 NORTH HARWOOD, SUITE 3400, DALLAS, TX, 75201, US

(21) Appl. No.: 09/943,171

(22) Filed: Aug. 30, 2001

(30) Foreign Application Priority Data
Sep. 4, 2000 (JP) 2000-266854

(51) Int. Cl. G08B 5/00; G02F 1/1339

(52) U.S. Cl. 349/155

(57) ABSTRACT

Disclosed is a non-flat liquid crystal display (LCD) element having a liquid crystal, a sealing wall and paired substrates opposed to each other such that a major surface of the LCD element has a non-flat form. In an aspect, spacers are disposed between the substrates, and a spacer density in a predetermined region is different from that in at least a portion of the other region. In another aspect, resin structures are disposed between the substrates and are adhered to the substrates, and a resin structure adhesion area, per unit area of the substrate, with respect to the substrate in a predetermined region is different from that in at least a portion of the other region. In further another aspect, at least one of pixel form, size and arrangement pitch in a predetermined region is different from that in at least a portion of the other region. In further another aspect, the resin structures are disposed between the substrates, and at least one of resin structure form, size and arrangement pitch in a predetermined region is different from that in at least a portion of the other region.

Also disclosed is a method of producing a non-flat LCD element. The method includes the steps of: holding a liquid crystal between paired flat substrates to produce a flat LCD element having an entirely flat form; and deforming the flat LCD element into a predetermined non-flat form.

### CROSS-REFERENCE TO RELATED APPLICATION

This application is based on Japanese Patent Application No. 2000-266854 filed in Japan on Sep. 4, 2000, the entire content of which is hereby incorporated by reference.

### BACKGROUND OF THE INVENTION

1. Field of the Invention

The present invention relates to a non-flat liquid crystal display element entirely having a not flat form. The invention also relates to a method of producing a non-flat liquid crystal display element.

2. Description of Related Art

In a liquid crystal display element, liquid crystal is arranged between two substrates, and display is performed by changing the orientation or arrangement state of molecules of the liquid crystal, e.g., by applying a voltage across electrodes formed on the substrates. A sealing wall for preventing leakage of the liquid crystal and spacers for keeping a constant gap between the substrates are generally arranged between the substrates. In some cases, resin structures adhering to each of the substrates are arranged between the substrates for increasing a whole strength of the liquid crystal display element or for other purposes.

In recent years, such a liquid crystal display element that employs polymer film substrates for holding the liquid crystal instead of glass substrates, has been practically used.

The liquid crystal display element using the polymer film substrates is superior to the liquid crystal display element using the glass substrates owing to its light weight and high resistance against breakage.

By using the polymer substrates, the liquid crystal display element can be flexible, and a non-flat liquid crystal display element having a curved display surface region can be easily produced.

The non-flat liquid crystal display element may be entirely curved, or may have both the flat and curved region. The non-flat liquid crystal display element can be used for various purposes. For example, in the case where the liquid crystal display element is installed onto an installation surface having a curved region, the non-flat liquid crystal display element having a form complementary in shape to the curved installation surface can be installed on the installation surface. In contrast to the above, it is difficult to install the flat liquid crystal display element on the curved installation surface.

In the non-flat liquid crystal display element, however, the non-flat form and the producing method or others may cause the following problems.

For example, when a certain force is applied to the non-flat liquid crystal display element having a flat region and a curved region neighboring thereto, a stress is often applied locally to the curved region or a boundary region between the curved and flat regions.

Therefore, an irregular gap between the substrates may occur in the curved region as well as in a boundary region between the curved and flat regions, even if the spacers, of which number is sufficient in the flat region for keeping the gap, are arranged in these regions. The irregular gap between the substrates causes irregularity in thickness of the liquid crystal. The irregularity in the liquid crystal thickness may cause irregularity in display, and particularly in half-tone display, which impedes good display.

Further more, the sealing wall and the resin structure are likely to be broken and/or are likely to be disengaged from the substrate in the curved region as well as in the boundary region between the curved and flat regions, on which the stress is likely to be concentrated. If the sealing wall is removed or disengaged from the substrate, the liquid crystal leaks therethrough, which impedes the display operation itself. If the sealing wall is disengaged from the substrate, the resin structure employed for joining the paired substrates together may likewise be disengaged from the substrate. The region where the resin structure is disengaged from the substrate may continuously expand from the position where the resin structure is first disengaged from the substrate. In the region where the resin structure is disengaged from the substrate, it is difficult to keep the gap between the substrates to a predetermined gap value due to a stress applied to the vicinity thereof, as described above.

The irregular gap as well as disengagement of the sealing wall and resin structure are more likely to occur as curvature of the curved region increases (i.e., as the radius of curvature of the curved region decreases).

The non-flat liquid crystal display element also suffers from such a problem that displayed images may be distorted due to the non-flat form, e.g., having a curved region.

In the non-flat liquid crystal display element, if the resin structures arranged between the substrates have substantially visible sizes, appearance difference may occur in form, size, arrangement pitch and/or others of the resin structures in the respective regions of the display element. This may impede the display observation.

### SUMMARY OF THE INVENTION

An object of the invention is to provide a non-flat liquid crystal display element, which can keep high uniformity in gap between substrates, and thereby can perform good display without color irregularity.

Another object of the invention is to provide a non-flat liquid crystal display element, which can suppress disengagement of a sealing wall from a substrate.

Still another object of the invention is to provide a non-flat liquid crystal display element, which can suppress distortion in a displayed image.

Further another object of the invention is to provide a non-flat liquid crystal display element, which can suppress lowering of visibility of a displayed image due to resin structures.

Further another object of the invention is to provide a method of producing a non-flat liquid crystal display element, which allows easy producing of the non-flat liquid crystal display element.

(1) Non-Flat Liquid Crystal Display Element

The invention provides the following four non-flat liquid crystal display elements.

(1-1) A liquid crystal display element (non-flat liquid crystal display element) including:

a pair of substrates;

a liquid crystal disposed between the substrates;

a plurality of spacers disposed between the substrates; and

a sealing wall disposed between the substrates and surrounding the liquid crystal, wherein

the substrates are spaced from each other by a constant distance kept by the spacers, and are opposed to each other such that a major surface of the liquid crystal display element has a non-flat form, and

a spacer density in a predetermined region of the liquid crystal display element is different from that in at least a portion of the other region.

(1-2) A liquid crystal display element (non-flat liquid crystal display element) including:

a pair of substrates;

a liquid crystal disposed between the substrates;

a plurality of resin structures disposed between the substrates and adhered to the substrates; and

a sealing wall disposed between the substrates and surrounding the liquid crystal, wherein

the substrates are opposed to each other such that a major surface of the liquid crystal display element has a non-flat form, and

a resin structure adhesion area, per unit area of the substrate, with respect to the substrate in a predetermined region of the liquid crystal display element is different from that in at least a portion of the other region.

(1-3) A liquid crystal display element (non-flat liquid crystal display element) including:

a pair of substrates;

a liquid crystal disposed between the substrates; and

a sealing wall disposed between the substrates and surrounding the liquid crystal, wherein

the substrates are opposed to each other such that a major surface of the liquid crystal display element has a non-flat form, and

at least one of a pixel form, a pixel size and a pixel arrangement pitch in a predetermined region of the liquid crystal display element is different from that in at least a portion of the other region.

(1-4) A liquid crystal display element (non-flat liquid crystal display element) including:

a pair of substrates;

a liquid crystal disposed between the substrates;

a plurality of resin structures disposed between the substrates; and

a sealing wall disposed between the substrates and surrounding the liquid crystal, wherein

the substrates are opposed to each other such that a major surface of the liquid crystal display element has a non-flat form, and

at least one of a form of the resin structure, a size of the resin structure and an arrangement pitch of the resin structures in a predetermined region of the liquid crystal display element is different from that in at least a portion of the other region.

(2) Method of Producing Non-Flat Liquid Crystal Display Element

The invention also provides the following four methods of producing a non-flat liquid crystal display element.

(2-1) A method of producing a non-flat liquid crystal display element including the steps of:

disposing spacers on at least one of paired flat substrates such that a spacer density in a predetermined region of the flat substrate is different from that in at least a portion of the other region;

holding a liquid crystal between the paired flat substrates carrying the spacers, and closing the substrates at a periphery of the liquid crystal by a sealing wall to produce a flat liquid crystal display element having an entirely flat form; and

deforming the flat liquid crystal display element into a predetermined non-flat form.

(2-2) A method of producing a non-flat liquid crystal display element including the steps of:

disposing resin structures on at least one of paired flat substrates such that a resin structure adhesion area, per unit area of the substrate, with respect to the substrate in a predetermined region of the flat substrate is different from that in at least a portion of the other region;

holding a liquid crystal between the paired flat substrates carrying the resin structures, and closing the substrates at a periphery of the liquid crystal by a sealing wall to produce a flat liquid crystal display element having an entirely flat form; and

deforming the flat liquid crystal display element into a predetermined non-flat form.

(2-3) A method of producing a non-flat liquid crystal display element including the steps of:

forming at least one electrode on each of paired flat substrates such that at least one of a pixel form, a pixel size and a pixel arrangement pitch in a predetermined region is different from that in at least a portion of the other region;

holding a liquid crystal between the paired flat substrates carrying the electrodes, and closing the substrates at a periphery of the liquid crystal by a sealing wall to produce a flat liquid crystal display element having an entirely flat form; and

deforming the flat liquid crystal display element into a predetermined non-flat form.

(2-4) A method of producing a non-flat liquid crystal display element including the steps of:

forming resin structures on at least one of paired flat substrates such that at least one of a form of the resin structure, a size of the resin structure and an arrangement pitch of the resin structures in a predetermined region of the flat substrate is different from that in at least a portion of the other region;

holding a liquid crystal between the paired flat substrates carrying the resin structures, and closing the substrates at a periphery of the liquid crystal by a sealing wall to produce a flat liquid crystal display element having an entirely flat form; and

deforming the flat liquid crystal display element into a predetermined non-flat form.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic perspective view of an example of a liquid crystal display element according to the invention.

FIG. 2(A) is a schematic plan of the liquid crystal display element shown in FIG. 1, and FIG. 2(B) is a schematic cross section of the liquid crystal display element shown in FIG. 1.

FIG. 3 is a fragmentary cross section of the liquid crystal display element in FIG. 1.

FIG. 4 shows a deforming step in a process of producing the liquid crystal display element in FIG. 1.

FIG. 5(A) is a schematic cross section of another example of the liquid crystal display element according to the invention, and FIG. 5(B) is a schematic plan of the same liquid crystal display element.

FIG. 6(A) is a schematic cross section of still another example of the liquid crystal display element according to the invention, and FIG. 6(B) is a schematic plan of the same liquid crystal display element.

FIG. 7 shows an example of arrangement of resin structures near a sealing wall in the liquid crystal display element of FIG. 6.

FIG. 8 is a schematic cross section of yet another example of the liquid crystal display element according to the invention.

FIG. 9(A) shows resin structures of the liquid crystal display element in FIG. 8 viewed from a predetermined observation direction, FIG. 9(B) is a schematic cross section of a region near a curved region of the liquid crystal display element in FIG. 8, and FIG. 9(C) shows the resin structures of the liquid crystal display element in FIG. 8 when the liquid crystal display element is in a flat form.

FIG. 10 shows an arrangement of further another example of the resin structures of the liquid crystal display element according to the invention.

FIG. 11(A) shows belt-like electrodes formed on one of the substrates of further another example of the liquid crystal display element according to the invention, and FIG. 11(B) shows belt-like electrodes formed on the other substrate.

FIG. 12 is a schematic cross section of further another example of the non-flat liquid crystal display element according to the invention.

FIG. 13 is a schematic cross section of further another example of the non-flat liquid crystal display element according to the invention.

FIG. 14 is a schematic cross section of further another example of the non-flat liquid crystal display element according to the invention.

FIG. 15 is a schematic perspective view of an example of a mobile telephone employing the non-flat liquid crystal display element in FIG. 1.

### DESCRIPTION OF THE PREFERRED EMBODIMENTS

§1. Non-Flat Liquid Crystal Display Element

In the following description, first to eighth types (i.e., eight types) of non-flat liquid crystal display elements are presented.

In this specification, the non-flat liquid crystal display element may have (1) a curved form having a single curvature, (2) a plurality of regions of different curvatures or (3) a plurality of flat regions of which normals extend in different directions. The non-flat liquid crystal display element of the above (2) may further have a flat region. The curved region of the non-flat liquid crystal display element of the above (1) or (2) may have two- or three-dimensional form.

§1.1. First to Eighth Types of Non-Flat Liquid Crystal Display Elements

First, structures and others common to the first to eighth types of the non-flat liquid crystal display elements will be described.

(a) Each type of the liquid crystal display element has a pair of substrates, a liquid crystal and a sealing wall.

The two substrates are opposed to each other with a space or gap therebetween. For example, spacers and/or resin structures may be employed for providing the gap between the substrates.

The liquid crystal is disposed between the two substrates.

The sealing wall is also disposed between the two substrates. The sealing wall is arranged to surround the liquid crystal for preventing leakage of the liquid crystal from a space between the substrates. The sealing wall is adhered to each of the substrates.

The substrate may be formed of a polymer film. Material for the polymer film substrate may be polyether sulfone (PES), polycarbonate (PC), polyethylene terephthalate (PET), polyarylate (PA), polyether ether ketone (PEEK) or annular amorphous polyolefine. The substrate may have a thickness, e.g., in a range from about 50 μm to about 1000 μm. By employing a thin substrate, the whole thickness and the weight of the liquid crystal display element can be reduced.

Each type of the liquid crystal display element may perform display in either of a light transmission type or a light reflection type.

A display mode of each type of the liquid crystal display element is not restricted. The display mode may be a twisted nematic (TN) mode, a super-twisted nematic (STN) mode, a cholesteric selective reflection mode, a dynamic scattering mode, a guest-host mode, an ECB mode, a phase change mode, a polymer dispersed liquid crystal mode, a ferroelectric liquid crystal mode or an anti-ferroelectric mode.

Each of the substrates is provided with at least one electrode for changing the molecular arrangement of the liquid crystal. The electrodes may be configured to perform simple matrix drive or active matrix drive. For example, the electrodes for the simple matrix drive may be configured such that a plurality of belt-like electrodes are formed on each of the two substrates (refer to first and second substrates), and the belt-like electrodes formed on the first substrate are perpendicular to those on the second substrate. For the active matrix drive, TFT or MIM elements or the like may be formed on the substrate together with the electrode.

If necessary, an orientation film, an insulating film, a gas barrier film and/or others may be formed on the substrate.

(b) The liquid crystal (liquid crystal composition) disposed between the substrates may be appropriately selected to satisfy the conditions for the required display mode of the liquid crystal display element. For example, nematic liquid crystal may be used for the TN mode. For the STN mode, liquid crystal including nematic liquid crystal and a minute amount of chiral material added thereto may be used. For the cholesteric selective reflection mode, cholesteric liquid crystal, or chiral nematic liquid crystal including nematic liquid crystal and a chiral material added thereto for exhibiting the cholesteric phase, may be used. For the dynamic scattering mode, liquid crystal including nematic liquid crystal having negative dielectric anisotropy and a conductive material such as electrolyte, which is dissolved in the nematic liquid crystal for reducing a specific resistance, may be used. For the guest-host mode, liquid crystal including host liquid crystal and dichromatic pigments added thereto as the guest may be used. For the ECB mode, liquid crystal including nematic liquid crystal having negative dielectric anisotropy and a chiral material added thereto may be used. For the phase change mode, cholesteric liquid crystal having positive dielectric anisotropy, or liquid crystal including nematic liquid crystal and nematic liquid crystal having positive dielectric anisotropy mixed thereto, may be used. For the polymer dispersed liquid crystal mode, nematic liquid crystal or cholesteric liquid crystal may be used. For the ferromagnetic liquid crystal mode, ferromagnetic liquid crystal may be used. For the anti-ferromagnetic liquid crystal mode, anti-ferromagnetic liquid crystal may be used.

Among them, the cholesteric selective reflection mode can perform bright display without a polarizing plate and a back light, and further can easily perform the full-color display. In this mode, the liquid crystal arranged between the substrates may be, e.g., a liquid crystal composition containing liquid crystal which exhibits a cholesteric phase, e.g., at a room temperature. The liquid crystal exhibiting the cholesteric phase selectively reflects the light of a wavelength corresponding to a helical pitch of the liquid crystal. Therefore, the liquid crystal display element including the liquid crystal, which exhibits the cholesteric phase, can be used as the liquid crystal display element of the reflection type. The liquid crystal exhibiting the cholesteric phase may additionally contain dye for adjusting the displayed color.

The liquid crystal exhibiting the cholesteric phase may be the cholesteric liquid crystal which exhibits the cholesteric phase by itself, or the chiral nematic liquid crystal which contains a nematic liquid crystal and a chiral agent added thereto. The chiral nematic liquid crystal has such an advantage that the helical pitch can be adjusted in accordance with an amount of added chiral agent, and thereby the selective reflection wavelength can be easily adjusted.

(c) Each type of the liquid crystal display element entirely has a form which is not flat (i.e., non-flat). The entire form of the liquid crystal display element may be determined substantially by the substrates, and the substrates may be opposed to each other such that a major surface of the non-flat display element has non-flat form. Thus, the paired substrates holding the liquid crystal are opposed to each other to provide the non-flat form of the liquid crystal display element.

Each type of the non-flat liquid crystal display element may have only a curved region having only a single curvature. Thus, each type of the non-flat liquid crystal display element may entirely have a concave form, a convex form or a cylindrically curved form having a single curvature.

(c1) Each of the first, second, fifth and sixth types of the non-flat liquid crystal display elements has, e.g., a first curved region and a second region, which neighbors the first curved region and has a smaller curvature than the first curved region.

The second region may be a flat region. The flat region can be considered as a region having an infinite radius (=∞) of curvature, i.e., an infinitesimal curvature (=1/∞). The flat region is a region having a smaller curvature than the curved region.

In stead of the flat region, the second region may be a second curved region.

Each of the first, second, fifth and sixth types of the non-flat liquid crystal display elements may have a region(s) other than the first curved region and the second region. Each of the first, second, fifth and sixth types of the non-flat liquid crystal display elements may have a curved region, which has the same curvature as the first curved region and does not neighbor to the first curved region, and/or a region, which has the same curvature as the second region and does not neighbor to the second region.

In summary, each of the first, second, fifth and sixth types of the non-flat liquid crystal display elements may have at least two regions, one of which is the curved region (first curved region) neighboring the second region having a smaller curvature than the first curved region.

(c2) Each of the third, fourth, seventh and eighth types of the non-flat liquid crystal display elements may have, e.g., first and second regions having different curvatures or normals of different directions. The first and second regions may or may not neighbor to each other. Each of the third, fourth, seventh and eighth types of the non-flat liquid crystal display elements may have one or more regions other than the first and second regions. For example, a third region neighboring both of the first and second regions may be arranged between these first and second regions.

The first and second regions may be flat regions, of which normals are different from each other. In this case, the first and second flat regions may be adjacent to each other. Alternatively, a curved region may be arranged between these first and second flat regions having different normals for smoothly connecting the first and second flat regions.

The first and second regions may be first and second curved regions having different curvatures.

The first and second regions may be a curved region and a flat region, respectively. In this case, the first region (curved region) and the second region (flat region) have different curvatures.

Each of the third, fourth, seventh and eighth types of the non-flat liquid crystal display elements may have only the curved region having a single curvature as described above. In this case, it can be deemed that the curved region having the single curvature is formed of a plurality of minute flat regions having normals of different directions. Therefore, the non-flat liquid crystal display element entirely having the curved form of the single curvature may be considered as the structure having the following first and second regions. Each of these first and second regions is a minute flat region, and the directions of the normals of the first and second regions (first and second minute flat regions) are different from each other.

(d) Each of the first to eighth types of the non-flat liquid crystal display elements may have a section which is not curved in a first direction as well as a curved section taken along a second direction perpendicular to the above first direction. In the following description, the non-flat liquid crystal display element of the above structure may be referred to as a “non-flat liquid crystal display element having a curvature or a curved section only in one direction” hereinafter.

Each type of the non-flat liquid crystal display element may have, e.g., a flat region and a curved region smoothly continuing to the flat region. The non-flat liquid crystal display element may have, e.g., a flat region and a curved region which are formed by smoothly bending at least a portion of the flat polymer film substrates, which can provide the non-flat liquid crystal display element having a curvature only in one direction.

§1.2. First and Fifth Types of Liquid Crystal Display Elements

In each of the first and fifth types of the non-flat liquid crystal display elements, a plurality of spacers are arranged between the substrates. Naturally, the non-flat liquid crystal display elements other than the first and fifth types of display elements may employ spacers between the substrates.

The spacers are arranged between the substrates for keeping a constant distance (gap) between these substrates in respective regions of the liquid crystal display element and/or for other purposes, in other words, for keeping a constant thickness of the liquid crystal and/or for other purposes.

The spacer may be a fixing type spacer which can be fixed to the substrates, or may be a non-fixing type spacer which is not to be fixed to the substrates. Thus, the spacers may be adhered or may not be adhered to the substrates.

The non-fixing type spacer may be formed of particle of a hard material, which is not deformed by a heat and/or a pressure. The non-fixing type spacer made of the hard material may be inorganic material particle such as fine glass fiber, ball of silicate glass or alumina powder, or organic compound spherical particle such as divinylbenzene cross-linking polymer particle or polystyrene cross-linking polymer particle.

The fixing type spacer may be a particle of thermoplastic resin. The fixing type spacer may be the non-fixing type spacer coated with hot-melt adhesive, thermosetting resin, UV-setting resin or the like.

§1.3. Second, Fourth, Sixth and Eighth Types of Liquid Crystal Display Elements

In each of the second, fourth, sixth and eighth types of the non-flat liquid crystal display elements, a plurality of resin structures are arranged between the substrates. Naturally, the first, third, fifth and seventh types of the non-flat liquid crystal display elements may have the resin structures arranged between the substrates.

The resin structures are arranged between the paired substrates. The resin structures are adhered to both the substrates. The resin structures join the substrates together with a space (gap) therebetween, and thereby can increase the whole strength of the liquid crystal display element. The resin structures can serve to keep the constant distance between the substrates. For example, the resin structures can keep the distance between the substrates while preventing increase in distance between the substrates.

The resin structure may be made of a material, which can be softened by heating, and can be hardened by cooling. The resin structure material is preferably selected from organic material, which does not chemically react with the liquid crystal material to be used, and has an appropriate elasticity. A resin structure material having such a feature may be a thermoplastic polymer material. The thermoplastic polymer material may be polyvinyl chloride resin, polyvinylidene chloride resin, polyvinyl acetate resin, polymethacrylate ester resin, polyacrylate ester resin, polystyrene resin, polyamide resin, polyethylene resin, polypropylene resin, fluororesin, polyurethane resin, polyacrylonitrile resin, polyvinyl ether resin, polyvinyl ketone resin, polyester resin, polyvinyl pyrolidone resin, saturated polyester resin, polycarbonate resin, chlorinated polyether resin or others. The resin structure material may be selected from various polymer materials such as a thermosetting polymer material or a photosetting polymer material, other than the thermoplastic polymer material. The resin structure may be made of a material, e.g., including one or more kinds of the resin materials among the above materials.

The resin structure may have, e.g., a dot-like columnar form having a circular section, a square section or an elliptic section. For example, an adhesion surface with respect to the substrate may be circular, elliptic, square or rectangular.

§2.

Description will be given on the respective types of the non-flat liquid crystal display elements.

§2.1. First and Fifth Types of Non-Flat Liquid Crystal Display Elements

The first type of the non-flat liquid crystal display element including:

a pair of substrates;

a liquid crystal disposed between the substrates;

a plurality of spacers disposed between the substrates; and

a sealing wall disposed between the substrates and surrounding the liquid crystal, wherein

a spacer density in a predetermined region of the liquid display element is different from that in at least a portion of the other region.

The fifth type of the non-flat liquid crystal display element including:

a pair of substrates;

a liquid crystal disposed between the substrates;

a plurality of spacers disposed between the substrates; and

a sealing wall disposed between the substrates and surrounding the liquid crystal, wherein

the substrates are spaced from each other by a constant distance kept by the spacers, and are opposed to each other such that a major surface of the liquid crystal display element has a non-flat form, and

a spacer density in a predetermined region of the liquid crystal display element is different from that in at least a portion of the other region.

Each of the first and fifth types of the non-flat liquid crystal display elements includes the pair of substrates, the liquid crystal, the plurality of spacers and the sealing wall. In the first or fifth type of the non-flat liquid crystal display element, resin structures may be arranged between the substrates.

In each of the first and fifth types of non-flat liquid crystal display elements, the spacer density in the predetermined region of the display element (i.e., the density of the spacer(s) arranged between predetermined regions of the substrates) is different from that in at least a portion of the other region.

In each of the first and fifth types of non-flat liquid crystal display elements, the spacer density in the following region may be different from that in the other region.

(a) For example, the spacer density in such a region that the gap between the substrates is likely to change may be larger than that in at least a portion of the other region. This can improve the uniformity in gap between the substrates throughout the non-flat liquid crystal display element. Also, this does not require increasing of the spacer density in the entire region but requires only locally increasing of the spacer density. Therefore, the uniformity in gap between the substrates can be improved throughout the non-flat liquid crystal display element without wasting the spacers. Thereby, the uniformity in liquid crystal thickness can be increased throughout the non-flat liquid crystal display element, and a high quality display can be performed without color irregularity.

(b) The spacer densities in the respective regions may be different such that the spacer density in an end region or a top region portion of the curved region (i.e., a region portion at and around the position of the curved region exhibiting the maximum value) is different from that in at least a portion of the other region. For example, the spacer density in the end region or the top region portion of the curved region may be larger than that in at least a portion of the other region. In the end region or the top region portion of the curved region, the gap between the substrates is more likely to change from the predetermined value than in the other region. When the first or fifth type of the non-flat liquid crystal display element is produced in a producing method described later, the curved region of the display element receives a force causing a return of the curved region to a flat form, and thereby the gap between the substrates in the curved region is liable to change from the predetermined value. A large force is liable to act on the end region and the top region portion of the curved region. Accordingly, by arranging the spacers in the end region or the top region portion of the curved region at a higher density than in at least a portion of the other region, the uniformity in gap between the substrates can be increased throughout the non-flat liquid crystal display element.

The spacer densities in the respective regions may be different in accordance with the curvatures of the respective regions. For example, the spacer density in the region of a large curvature may be larger than that in the region of a small curvature. In the region of a large curvature, the gap between the substrates is more likely to change from the predetermined value than in the region of a small curvature. A large force is liable to act on the region of a large curvature. Accordingly, by arranging the spacers in the region of a large curvature at a higher density than that in the region of a small curvature, the uniformity in gap between the substrates can be increased throughout the non-flat liquid crystal display element.

The spacer density in a certain region (refer to first region) may be determined in accordance with, e.g., the curvature of the first region, the curvature of a region neighboring the first region and/or others.

(c) As already described, each of the first and fifth types of non-flat liquid crystal display elements may have two regions (refer to large and small curvature regions), which have different curvatures and neighbor to each other. The spacer densities in these large and small curvature regions may be different as follows.

For example, the spacer density in the boundary region between the large and small curvature regions may be different from that in at least a portion of the other region. The boundary region between the large and small curvature regions is composed of a region portion, adjacent to the small curvature region, of the large curvature region and a region portion, adjacent to the large curvature region, of the small curvature region, in other words, is composed of a region portion, close to the small curvature region, of the large curvature region and a region portion, close to the large curvature region, of the small curvature region. The spacer densities in the large and small curvature regions may be determined, for example, to satisfy one or more of the following relationships.

The spacer density in the boundary region between the large and small curvature regions may be, for example, larger than the spacer density in the small curvature region except for a boundary with any other region. The boundary of the small curvature region with any other region includes a boundary region portion of the small curvature region with respect to the large curvature region. In the case where the small curvature region is adjacent to another region (refer to third region) of a different curvature other than the large curvature region, the boundary of the small curvature region with any other region further includes a boundary region portion of the small curvature region with respect to the third region.

The spacer density in the large curvature region except for a boundary with any other region may be larger than the spacer density in the small curvature region except for the boundary with any other region. The boundary of the large curvature region with any other region includes a boundary region portion of the large curvature region with respect to the small curvature region. In the case where the large curvature region is adjacent to another region (refer to fourth region) of a different curvature other than the small curvature region, the boundary of the large curvature region with any other region further includes a boundary region portion of the large curvature region with respect to the fourth region.

The spacer density in the boundary region between the large and small curvature regions may be equal to the spacer density in the large curvature region except for the boundary with any other region.

By providing the different spacer densities in the two neighboring regions of different curvatures as described above, it is possible to increase the uniformity in gap between the substrates in the boundary region, which is likely to receive a force acting to restore the structure into a flat form and likely to receive a large load.

The size of the boundary region between the large and small curvature regions may be determined in accordance with the difference in curvature between these regions. For example, the size of the boundary region between the large and small curvature regions may be determined to be larger as the curvature difference between these regions increases.

In the case where the first or fifth type of the non-flat liquid crystal display element has two or more region sets, each of which includes the two neighboring regions having different curvatures, the above relationship in spacer density may be satisfied between the neighboring two regions in at least one of the sets, and may be satisfied between the neighboring two regions of each of the sets.

As described above, each of the first and fifth types of non-flat liquid crystal display elements may have, e.g., the first curved region and the second region, which neighbors the first curved region and has a smaller curvature than the first curved region.

The first curved region is the foregoing large curvature region, and the second region is the foregoing small curvature region. The second region may be the flat region or the curved region (second curved region).

The spacer density in the boundary region between the first curved region and the second region may be larger than that in the second region except for the boundary with any other region.

The spacer density in the first curved region except for the boundary with any other region may be larger than that in the second region except for the boundary with any other region.

The spacer density in the boundary region between the first curved region and the second region may be equal to that in the first curved region except for the boundary with any other region.

The spacer density in the boundary region between the first curved region and the second region may be different from the spacer density in the second region except for the boundary with any other region.

§2.2. Second and Sixth Types of Non-Flat Liquid Crystal Display Elements

The second type of the non-flat liquid crystal display element including:

a pair of substrates;

a liquid crystal disposed between the substrates;

a plurality of resin structures disposed between the substrates and adhered to the substrates; and

a sealing wall disposed between the substrates and surrounding the liquid crystal, wherein

a resin structure adhesion area, per unit area of the substrate, with respect to the substrate in a predetermined region is different from that in at least a portion of the other region.

The sixth type of the non-flat liquid crystal display element including:

a pair of substrates;

a liquid crystal disposed between the substrates;

a plurality of resin structures disposed between the substrates and adhered to the substrates; and

a sealing wall disposed between the substrates and surrounding the liquid crystal, wherein

the substrates are opposed to each other such that a major surface of the liquid crystal display element has a non-flat form, and

a resin structure adhesion area, per unit area of the substrate, with respect to the substrate in a predetermined region of the liquid crystal display element is different from that in at least a portion of the other region.

Each of the second and sixth types of the non-flat liquid crystal display elements includes the pair of substrates, the liquid crystal, the plurality of resin structures and the sealing wall. In the second and sixth types of the non-flat liquid crystal display elements, the spacers may be arranged between the substrates.

In the second and sixth types of the non-flat liquid crystal display elements, the resin structure adhesion area, per unit area of the substrate, with respect to the substrate in the following region may be different from that in at least a portion of the other region.

(a) For example, the resin structure adhesion area, per unit area of the substrate, with respect to the substrate may be larger in a region which is liable to receive a force acting to return it into a flat form and/or liable to receive a load than in at least a portion of the other region. Thereby, it is possible to suppress the disengagement of the resin structure from the substrate in the region which is liable to receive the force acting to return it into a flat form and/or liable to receive a load. This can improve the uniformity in gap between the substrates throughout the non-flat liquid crystal display element. It is also possible to suppress disengagement of the sealing wall from the substrate, and therefore, leakage of the liquid crystal.

(b) The resin structure adhesion areas per unit area of the substrate with respect to the substrate in the respective regions may be different such that the resin structure adhesion area, per unit area of the substrate, with respect to the substrate in an end region or a top region portion of the curved region (i.e., a region portion at and around the position of the curved region exhibiting the maximum value) is different from that in at least a portion of the other region. For example, the resin structure adhesion area, per unit area of the substrate, with respect to the substrate in the end region or the top region portion of the curved region may be larger than that in at least a portion of the other region. The resin structures in the end region and the top region portion of the curved region are more likely to receive a load or stress than the resin structures in the region of the small curvature, and thereby disengagement of the resin structure is more likely to occur in those regions. When the second or sixth type of the non-flat liquid crystal display element is produced in a producing method described later, the curved region of the display element receives a force causing a return of the curved region to a flat form, and thereby the disengagement of the resin structures is more likely to occur in that region. A large force is liable to act on the end region and the top region portion of the curved region, and thereby the disengagement of the resin structures is more likely to occur in those regions. By arranging the resin structures in the end region and/or the top region portion of the curved region at a larger adhesion area per unit area of the substrate than in at least a portion of the other region, the uniformity in gap between the substrates can be increased throughout the non-flat liquid crystal display element.

The resin structure adhesion areas, per unit area of the substrate, with respect to the substrate in the respective regions may be different in accordance with the curvatures of the respective regions. For example, the resin structure adhesion area, per unit area of the substrate, with respect to the substrate in the region of a large curvature may be larger than that in the region of a small curvature. The resin structure in the region of a large curvature is more likely to receive a load or stress than the resin structure in the region of a small curvature, and thereby the disengagement of the resin structure is more likely to occur in the region of the large curvature. A larger force acts on the region of curved region as the curvature increases, and thereby the disengagement of the resin structure is more likely to occur in the larger curvature region. By arranging the resin structures in the region of a large curvature at a larger adhesion area per unit area of the substrate than that in the region of a small curvature, the uniformity in gap between the substrates can be increased throughout the non-flat liquid crystal display element.

The resin structure adhesion area, per unit area of the substrate, with respect to the substrate in a certain region (refer to fourth region) may be determined in accordance with the curvature of the fourth region, the curvature of a region neighboring the fourth region and/or others.

(c) As already described, each of the second and sixth types of the non-flat liquid crystal display elements may have two regions (refer to large and small curvature regions) which have different curvatures and neighbor to each other. The adhesion areas of the resin structures with respect to the substrate per unit area of the substrate in these large and small curvature regions may be different as follows.

For example, the resin structure adhesion area, per unit area of the substrate, with respect to the substrate in the boundary region between the large and small curvature regions may be different from that in at least a portion of the other region. The resin structure adhesion areas, per unit area of the substrate, with respect to the substrate in the large and small curvature regions may be determined, for example, to satisfy one or more of the following relationships.

The resin structure adhesion area, per unit area of the substrate, with respect to the substrate in the boundary region between the large and small curvature regions may be larger than that in the small curvature region except for the boundary with any other region.

The resin structure adhesion area, per unit area of the substrate, with respect to the substrate in the large curvature region except for the boundary with any other region may be larger than that in the small curvature region except for the boundary with any other region.

The resin structure adhesion area, per unit area of the substrate, with respect to the substrate in the boundary region between the large and small curvature regions may be equal to that in the large curvature region except for the boundary with any other region.

By providing the different resin structure adhesion areas of the resin structures with respect to the substrate per unit area of the substrate in the two neighboring regions of different curvatures as described above, it is possible to suppress the disengagement of the resin structure from the substrate even in the boundary region which is likely to receive a load or the like.

In the case where the second or sixth type of the non-flat liquid crystal display element has two or more region sets, each of which includes the two neighboring regions having different curvatures, the above relationship in resin structure adhesion area with respect to the substrate per unit area of the substrate may be satisfied between the two neighboring regions in at least one of the sets, or may be satisfied between the two neighboring regions of each of the sets.

As described above, each of the second and sixth types of the non-flat liquid crystal display elements may have the first curved region and the second region which neighbors the first curved region and has a smaller curvature than the first curved region.

The resin structure adhesion area, per unit area of the substrate, with respect to the substrate in the boundary region between the first curved region and the second region may be larger than that in the second region except for the boundary with any other region.

The resin structure adhesion area, per unit area of the substrate, with respect to the substrate in the first curved region except for the boundary with any other region may be larger than that in the second region except for the boundary with any other region.

The resin structure adhesion area, per unit area of the substrate, with respect to the substrate in the boundary region between the first curved region and the second region may be equal to that in the first curved region except for the boundary with any other region.

The resin structure adhesion area, per unit area of the substrate, with respect to the substrate in the boundary region between the first curved region and the second region may be different from that in the second region except for the boundary with any other region.

(d) The resin structure adhesion area, per unit area of the substrate, with respect to the substrate in a region near the sealing wall may be larger than that in the region of the second region except for the boundary region with any other region and except for the second region portion near the sealing wall. By increasing the resin structure adhesion area with respect to the substrate per unit area of the substrate in the region near the sealing wall as described above, it is possible to increase the adhesion force of the total resin structures to the substrate in the region near the sealing wall. Thereby, it is possible to suppress disengagement of the sealing wall from the substrate.

In the non-flat liquid crystal display element having the curved region which is prepared by curving or bending a flat liquid crystal display element, a force may act on the two substrates to shift them in a direction parallel to the substrate surface, e.g., due to the difference in curvature between the two substrates in the curved region. This force increases with increase in curvature. However, by increasing the adhesion force of the total resin structures to the substrate in the region near the sealing wall, it is possible to suppress disengagement of the sealing wall from the substrate and therefore leakage of the liquid crystal.

(e) The resin structure adhesion area, per unit area of the substrate, with respect to the substrate in a certain region may be different from that in the other region in the following manner.

For example, the adhesion area of each resin structure with respect to the substrate may be constant in all the regions, in which case the number of the resin structures per unit area of the substrate (density in number) may be increased in the region where the resin structure adhesion area, per unit area of the substrate, with respect to the substrate is to be large. The density in number of the resin structures can be increased by decreasing the arrangement pitch of the resin structures. The pitch of the resin structures in the direction along which the display element is curved may be different from that in the direction along which the display element is not curved. For example, the pitch of the resin structures in the direction along which the display element is not curved may be constant, and the pitch of the resin structures in the direction along which the display element is curved may be different in accordance with the angle between the normal of each region and a predetermined observation direction. The arrangement pitch of the resin structures is the actual distance between the neighboring resin structures in the case where the resin structures formed on the substrate are equally spaced from each other. In the case where the resin structures formed on the substrate are unequally spaced from each other, the arrangement pitch of the resin structures is an average of the distances between the neighboring resin structures.

The number of the resin structures per unit area of the substrate may be constant in all the regions, in which case the adhesion area of each resin structure with respect to the substrate may be increased in the region where the resin structure adhesion area, per unit area of the substrate, with respect to the substrate is to be large. For example, the adhesion area of each resin structure with respect to the substrate may be changed by changing the form and/or the size of the adhesion surface of the resin structure with respect to the substrate.

The resin structure adhesion area, per unit area of the substrate, with respect to the substrate may be changed by changing both the adhesion area of each resin structure with respect to the substrate in each region and the number of the resin structures per unit area of the substrate in each region.

In the second and sixth types of the non-flat liquid crystal display elements, as described above, at least one of the following three parameters in a predetermined region of the display element may be different from that or those in at least a portion of the other region.

The three parameters are:

(1) resin structure form (e.g., a form of the adhesion surface with respect to the substrate),

(2) resin structure size (e.g., a size of the adhesion surface with respect to the substrate), and

(3) resin structure arrangement pitch.

In the case where the resin structure adhesion area, per unit area of the substrate, with respect to the substrate in the predetermined region is different from that in at least a portion of the other region, the change occurs in one or more of the form of the adhesion surface with respect to the substrate, the size of the adhesion surface with respect to the substrate and the arrangement pitch of the resin structures.

§2.3. Third and Seventh Types of Non-Flat Liquid Crystal Display Elements

The third type of the non-flat liquid crystal display element including:

a pair of substrates;

a liquid crystal disposed between the substrates; and

a sealing wall disposed between the substrates and surrounding the liquid crystal, wherein

at least one of three parameters of a pixel form, a pixel size and a pixel arrangement pitch in a predetermined region is different from that in at least a portion of the other region.

The seventh type of the non-flat liquid crystal display element including:

a pair of substrates;

a liquid crystal disposed between the substrates; and

a sealing wall disposed between the substrates and surrounding the liquid crystal, wherein

the substrates are opposed to each other such that a major surface of the liquid crystal display element has a non-flat form, and

at least one of a pixel form, a pixel size and a pixel arrangement pitch in a predetermined region of the liquid crystal display element is different from that in at least a portion of the other region.

Each of the third and seventh types of the non-flat liquid crystal display elements includes the pair of substrates, the liquid crystal and the sealing wall. In the fourth and eighth types of the liquid crystal display elements, spacers and/or resin structures may be arranged between the substrates.

In the third and seventh types of the non-flat liquid crystal display elements, at least one of the following parameters in the predetermined region of the display element is different from that in at least a portion of the other portion.

The three parameters are:

(1) pixel form,

(2) pixel size, and

(3) pixel arrangement pitch.

For example, at least one of the pixel form, the pixel size and the pixel arrangement pitch is different between regions of the liquid crystal display element so that at least corresponding one of the pixel form, the pixel size and the pixel arrangement pitch in all the regions of the liquid crystal display element appears same or substantially same when viewed from a predetermined observation direction.

More specifically, for eliminating or reducing the difference in pixel form between the respective regions when viewed from the predetermined observation direction, the forms of the pixels in the respective regions may be changed.

For eliminating or reducing the difference in pixel size between the respective regions when viewed from the predetermined observation direction, the sizes of the pixels in the respective regions may be changed.

For eliminating or reducing the difference in pixel arrangement pitch between the respective regions when viewed from the predetermined observation direction, the arrangement pitches of the pixels in the respective regions may be changed.

The pixel form, size and arrangement pitch may be changed in accordance with an angle between a normal of each region and the predetermined observation direction. Thereby, at least one of the pixel form, size and arrangement pitch in each region appears equal or substantial equal to that in the other region when viewed from the predetermined observation direction. Accordingly, it is possible to suppress distortion in display on the non-flat liquid crystal display element. In the case where the third or seventh type of the non-flat liquid crystal display element has the flat region, the observation direction may be normal to the flat region.

The pixel form, size and/or arrangement pitch can be changed, e.g., in the following manner. In the non-flat liquid crystal display element of the simple matrix drive type, the pixel form, size and/or arrangement pitch can be changed by changing a width, a pitch and/or others of a plurality of belt-like electrodes arranged on each substrate.

§2.4. Fourth and Eighth Type of Non-Flat Liquid Crystal Display Elements

The fourth type of the non-flat liquid crystal display element including:

a pair of substrates;

a liquid crystal disposed between the substrates;

a plurality of resin structures disposed between the substrates; and

a sealing wall disposed between the substrates and surrounding the liquid crystal, wherein

at least one of three parameters of a resin structure form, a resin structure size and a resin structure arrangement pitch in a predetermined region of the liquid crystal display element is different from that in at least a portion of the other region.

The eighth type of non-flat liquid crystal display element including:

a pair of substrates;

a liquid crystal disposed between the substrates;

a plurality of resin structures disposed between the substrates; and

a sealing wall disposed between the substrates and surrounding the liquid crystal, wherein

the substrates are opposed to each other such that a major surface of the liquid crystal display element has a non-flat form, and

at least one of a form of the resin structure, a size of the resin structure and an arrangement pitch of the resin structures in a predetermined region of the liquid crystal display element is different from that in at least a portion of the other region.

Each of the fourth and eighth types of the non-flat liquid crystal display elements includes the pair of substrates, the liquid crystal, the plurality of resin structures and the sealing wall. In the fourth or eighth type of the liquid crystal display element, spacers may be arranged between the substrates.

In each of the fourth and eighth types of the non-flat liquid crystal display elements, at least one of the following three parameters in the predetermined region of the display element is different from that in at least a portion of the other region.

The three parameters are:

(1) resin structure form (e.g., a form of the adhesion surface of the resin structure with respect to the substrate),

(2) resin structure size (e.g., a size of the adhesion surface of the resin structure with respect to the substrate), and

(3) resin structure arrangement pitch.

For example, at least one of the resin structure form, the resin structure size and the resin structure arrangement pitch is different between regions of the liquid crystal display element so that at least corresponding one of the resin structure form, the resin structure size and the resin structure arrangement pitch in all the regions of the liquid crystal display element appears same or substantially same when viewed from a predetermined observation direction.

More specifically, for eliminating or reducing the difference in resin structure form between the respective regions when viewed from the predetermined observation direction, the forms of the resin structures in the respective regions may be changed.

For eliminating or reducing the difference in resin structure size between the respective regions when viewed from the predetermined observation direction, the sizes of the resin structures in the respective regions may be changed.

For eliminating or reducing the difference in resin structure arrangement pitch between the respective regions when viewed from the predetermined observation direction, the arrangement pitches of the resin structures in the respective regions may be changed.

The resin structure form, size and/or arrangement pitch may be changed in accordance with the angle of the normal of each region with respect to the predetermined observation direction. Thereby, at least one of the resin structure form, size and arrangement pitch in each region appears equal or substantial equal to that in the other region when viewed from the predetermined observation direction. Accordingly, even if each of the resin structures has a visible size, the non-flat liquid crystal display element can perform display with less interference due to the resin structures because the resin structures in the respective regions appear the same or substantial same form, size and/or arrangement pitch when viewed from the predetermined observation direction. Thus, it is possible to suppress the influence by the resin structures on the image or content displayed by the display element. In the case where the fourth or eighth type of the non-flat liquid crystal display element has the flat region, the observation direction may be normal to the flat region.

The resin structure arrangement pitch in the direction along which the display element is curved may be different from that in the direction along which the display element is not curved. For example, the pitch of the resin structures in the direction along which the display element is not curved may be constant, and the pitch of the resin structures in the direction along which the display element is curved may be different in accordance with the angle of the normal of each region and the predetermined observation direction.

§3.

Two or more of the structures of the first to eighth types of the non-flat liquid crystal display elements described above may be employed in combination.

For example, the structure of the first type of the non-flat liquid crystal display element may be combined with the structure of the second, third or fourth type of the non-flat liquid crystal display element. The structure of the fifth type of the non-flat liquid crystal display element may be combined with the structure of the sixth, seventh or eighth type of the non-flat liquid crystal display element.

The structure of the second type of the non-flat liquid crystal display element may be combined with the structure of the third or fourth type of the non-flat liquid crystal display element. The structure of the sixth type of the non-flat liquid crystal display element may be combined with the structure of the seventh or eighth type of the non-flat liquid crystal display element.

The structure of the third type of the non-flat liquid crystal display element may be combined with the structure of the fourth type of the non-flat liquid crystal display element. The structure of the seventh type of the non-flat liquid crystal display element may be combined with the structure of the eighth type of the non-flat liquid crystal display element.

§4. Method of Producing Non-Flat Liquid Crystal Display Element

In the following description, a method of producing a non-flat liquid crystal display element is presented.

The producing method includes a flat element forming step and a deforming step. In the flat element forming step, a flat liquid crystal display element entirely having a flat form is formed using a pair of flat substrates. In the flat element forming step, the liquid crystal may be held between the flat substrates, e.g., carrying the spacers and/or resin structures, and the flat substrates may be closed at a periphery of the liquid crystal (that is, the periphery of the liquid crystal may be sealed between the substrates) by a sealing wall to produce the flat liquid crystal display element. In the deforming step, the flat liquid crystal display element prepared in the flat element forming step is deformed (e.g., curved) into a predetermined non-flat form.

The producing method can be applied to production of any one of the first to eighth types of the non-flat liquid crystal display elements. Thus, the method can produce any one of the first to eighth types of the non-flat liquid crystal display elements.

For producing the first or fifth type of the non-flat liquid crystal display element, the producing method further includes a spacer disposing step of disposing spacers on at least one of the flat substrates such that a spacer density in a predetermined region of the flat substrate is different from that in at least a portion of the other region, in other words, such that a spacer density in a predetermined region of the non-flat liquid crystal display element to be produced is different from that in at least a portion of the other region. The spacer disposing step may be performed before the deforming step, and may be performed before or during the flat element forming step.

For producing the second or sixth type of the non-flat liquid crystal display element, the producing method further includes a resin structure disposing (forming) step of disposing (forming) resin structures on at least one of the flat substrates such that a resin structure adhesion surface, per unit area of the substrate, with respect to the substrate in a predetermined region of the flat substrate is different from that in at least a portion of the other region, in other words, such that a resin structure adhesion surface, per unit area of the substrate, with respect to the substrate in a predetermined region of the non-flat liquid crystal display element to be produced is different from that in at least a portion of the other region. The resin structure disposing step may be performed before the deforming step, and may be performed before or during the flat element forming step.

For producing the third or seventh type of the non-flat liquid crystal display element, the producing method further includes an electrode forming step of forming at least one electrode on each of the flat substrates such that at least one of three parameters of a pixel form, a pixel size and a pixel arrangement pitch in a predetermined region of the non-flat liquid crystal display element to be produced is different from that in at least a portion of the other region. The electrode forming step may be performed before the deforming step, and may be performed before or during the flat element forming step.

For producing the fourth or eighth type of the non-flat liquid crystal display element, the producing method further includes a resin structure disposing (forming) step of disposing (forming) resin structures on at least one of the flat substrates such that at least one of a resin structure form, a resin structure size and a resin structure arrangement pitch in a predetermined region of the flat substrate is different from that in at least a portion of the other region, in other words, such that at least one of a resin structure form, a resin structure size and a resin structure arrangement pitch in a predetermined region of the non-flat liquid crystal display element to be produced is different from that in at least a portion of the other region. The resin structure disposing step may be performed before the deforming step, and may be performed before or during the flat element forming step.

In the flat element forming step, the flat liquid crystal display element having the inner structure already described is produced. More specifically, the flat liquid crystal display element to be formed in the flat element forming step has the following inner structure. The liquid crystal is disposed between the paired substrates. At least one electrode is formed on each of the substrates for display driving. If necessary, the orientation film, insulating film, gas barrier film or others may be formed on the substrate. The sealing wall surrounding the liquid crystal is formed between the substrates. For the liquid crystal display element employing the spacers, the spacers are disposed between the substrates. For the liquid crystal display element employing the resin structures, the resin structures are disposed between the substrates. A conventional manner can be employed for producing the flat liquid crystal display element described above.

In the deforming step, the flat liquid crystal display element prepared in the flat element forming step is deformed into an intended or predetermined non-flat form. By deforming the flat liquid crystal display element into the non-flat form, the non-flat liquid crystal display element is obtained. In the deforming step, at least a portion of the flat liquid crystal display element may be curved.

For producing the first, second, fifth or sixth type of the non-flat liquid crystal display element, the flat liquid crystal display element may be deformed into the non-flat form to provide, e.g., a first curved region and a second region, which neighbors the first curved region and has a smaller curvature than the first curved region.

For producing the third, fourth, seventh or eighth type of the non-flat liquid crystal display element, the flat liquid crystal display element may be deformed into the non-flat form to provide, e.g., first and second regions having different curvatures or normals in different directions.

For producing any one of the foregoing types of the non-flat liquid crystal display elements, a polymer substrate may be employed as the substrate. In this case, the substrate of the polymer film may be bent to deform the flat liquid crystal display element into the non-flat form in the deforming step.

The predetermined non-flat form of the non-flat liquid crystal display element thus obtained by deforming the flat liquid crystal display element may be kept, e.g., by joining one of the substrates to a support member having a surface extending along the predetermined non-flat form of the non-flat liquid crystal display element with adhesive.

According to the producing method described above, the liquid crystal display element of the flat form is first formed, and then is deformed into a predetermined non-flat form. Therefore, the flat element forming step can employ a conventional manner and a conventional producing apparatus. More specifically, the non-flat liquid crystal display element can be produced without using a substrate that has an initially non-flat form. This allows easy and efficient producing of the non-flat liquid crystal display element.

According to the producing method described above, the flat element forming step can be performed similarly even when producing the non-flat liquid crystal display elements of different non-flat forms. This allows efficient producing of the non-flat liquid crystal display elements of different non-flat forms.

In contrast to the producing method described above, the non-flat liquid crystal display elements of different non-flat forms may be produced using such substrates that have non-flat forms in the initial state. In this case, the non-flat substrates having different non-flat forms must be prepared, and it is necessary to prepare jigs, producing devices and others corresponding to such different forms, or to prepare a jig, a device and others which can be commonly used to different forms. However, according to the producing method described above, the non-flat liquid crystal display elements of different forms can be produced without using several or various kinds of jigs, producing devices and others corresponding to the different forms, and thus can be produced with a single kind of jig, device and others, provided that the sizes of the substrates in the flat element forming step are same. The producing method described above can reduce the number of the jig, producing device and others required for producing the non-flat liquid crystal display elements of different forms.

Although the flat liquid crystal display element is deformed into the non-flat form, the non-flat liquid crystal display element produced in the above method can have high uniformity in gap between the substrates and/or can have high strength by changing the spacer density, the adhesion area of the resin structure to the substrate and/or others in accordance with the curvature and/or the others as already described.

Each of the first to eighth types of the non-flat liquid crystal display elements may be a product of the producing method described above. Thereby, the first to eighth types of the non-flat liquid crystal display elements can be produced easily and efficiently, and thus can be inexpensive.

In the flat element forming step, the spacers and the resin structures may be disposed between the substrates in the following manner. The sealing wall may be formed in the following manner.

The spacers can be disposed between the substrates, e.g., by dispersing the spacers on at least one of the substrates before overlapping the substrates with each other. The spacers may be dispersed on the substrate by a known manner such as a wet dispersing manner or a dry dispersing manner. For changing the spacer densities depending on the regions, different masks may be used for region requiring different densities, respectively, and the dispersion of the spacers may be performed two or more times. The spacer densities can also be changed depending on the regions in such a manner that the dispersion is performed while keeping only the substrate region to be small density in the curved or inclined state. For example, by inclining the dispersion direction of the spaces with respect to the substrate surface, the substrate surface facing in the dispersion direction is increased so that the spacer dispersion density can be smaller than that in the case where the spacer dispersion direction is perpendicular to the substrate surface.

The resin structures may be formed on at least one of the substrates before overlaying the two substrates with each other. The resin structure may be formed by a printing method, in which a paste material containing resin (e.g., resin dissolved in solvent or mixture of monomer and polymerization initiator) is applied onto the substrate by a squeeze through a screen or metal mask. The resin structure may be formed in a dispenser method or an ink-jet method, in which the resin is applied onto the substrate from a nozzle. The resin structure may be formed in a transfer method, in which the resin is first applied onto a flat plate or a roller, and then is transferred onto the substrate. Preferably, the resin structure thus formed on the substrate initially has a height, which is larger than the intended thickness of the liquid crystal (gap between the substrates), in view of the purpose of the resin structures, that is, joining the substrates together.

The sealing wall may be formed on the substrate before overlaying the substrates with each other. The sealing wall may be made of resin such as UV-setting resin or thermosetting resin. The sealing wall may be formed, e.g., in a dispenser method or an ink-jet method, in which the resin is applied onto the substrate from the nozzle. The seal wall may be formed in a printing method using a screen, a metal mask or the like. The sealing wall may be formed in a transfer method, in which the resin is first applied onto a flat plate or a roller, and then is transferred onto the substrate.

The liquid crystal to be disposed between the substrates may be supplied onto at least one of the substrates before and/or during the operation of overlaying the substrates with each other. The liquid crystal may be filled into a space defined by the substrates and the sealing wall after overlaying the substrates with each other. The filling of the liquid crystal into this space may be performed by a vacuum filling method. In the case where the liquid crystal is filled into the space defined by the substrates and the sealing wall after overlaying the substrates with each other, the liquid crystal may be filled into the space before or after deforming the flat liquid crystal display element into the non-flat form.

§5.

With reference to the drawings, embodiments of the non-flat liquid crystal display element as well as the method of producing the non-flat liquid crystal display element are described below.

The following embodiments will be described together with specific material names and numeric values. However, these are described only for easy understanding, and the invention is not restricted to them.

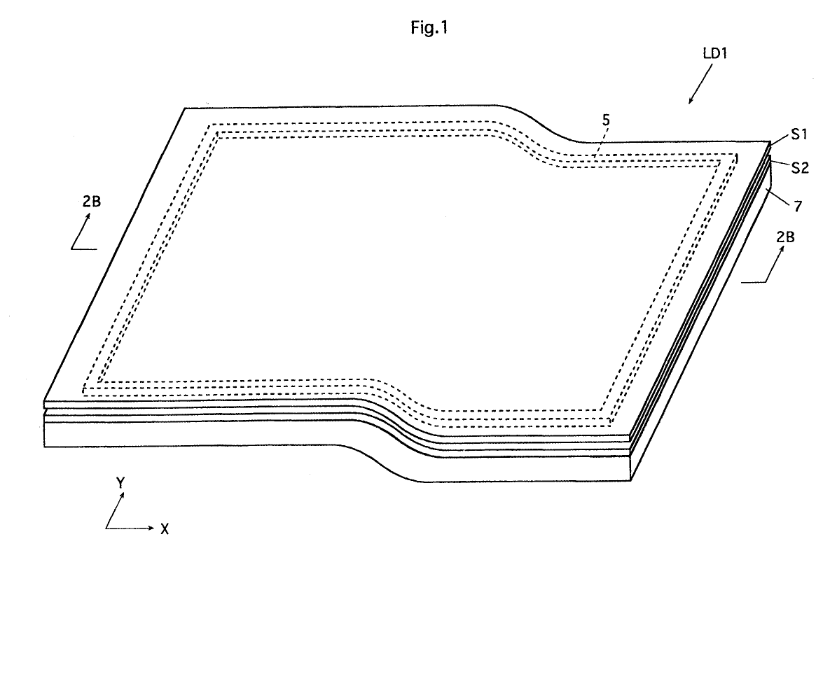

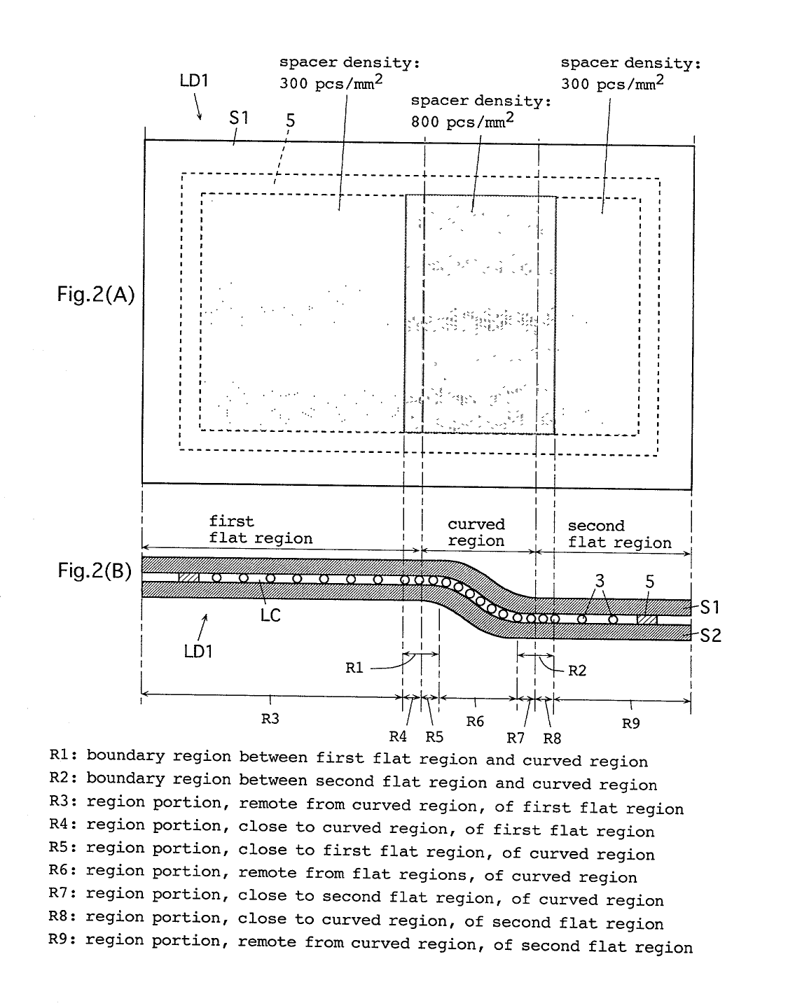

An example of the non-flat liquid crystal display element is shown in a schematic perspective view of FIG. 1. FIG. 2(A) is a schematic plan of the same non-flat liquid crystal display element. FIG. 2(B) is a schematic cross section of the same non-flat liquid crystal display element taken along line 2B-2B in FIG. 1.

A non-flat liquid crystal display element LD1 in FIGS. 1, 2(A) and 2(B) is a liquid crystal display element of a light reflection type.

The liquid crystal display element LD1 entirely has a non-flat form. The non-flat liquid crystal display element LD1 has first and second flat regions and a curved region, as shown in FIG. 2(B).

The curved region is located between the first and second flat regions. A difference in level is present between the first and second flat regions. These flat regions are smoothly joined together by the curved region without an edge or the like. When viewed from an observation or viewing direction, the curved region has a convexly curved region portion and a concavely curved region portion, both of which have an equal curvature in this embodiment.

A normal of the first flat region (i.e., a line perpendicular to the first flat region) extends in the same direction as a normal of the second flat region. Thus, the first and second flat regions are parallel to each other, and the difference in level is present between these flat regions.

In the non-flat liquid crystal display element LD1, a curvature is present in a direction X shown in FIG. 1, and a curvature is not present in a direction Y perpendicular to the direction X. In other words, a section of the non-flat liquid crystal display element LD1 (see FIG. 2(B)) along the direction X has a non-linear form (including a curved line), and a section thereof along the direction Y has a linear form.

The non-flat liquid crystal display element LD1 has two substrates S1 and S2 for holding the liquid crystal therebetween and other purposes. The substrates S1 and S2 are polymer film substrates, and are flexible. The foregoing non-flat form of the liquid crystal display element LD1 is achieved by bending these substrates S1 and S2.

The foregoing non-flat form of the non-flat liquid crystal display element LD1 is maintained by a support member 7 (see FIG. 1) adhered to a backside of the substrate S2 by adhesive. The support member 7 is not shown in the figures other than FIG. 1. The support member 7 in this embodiment is made of acrylic resin, and is hardly flexible. An adhesive film is used as the adhesive for adhering the support member 7 to the substrate S2 in this embodiment.

The liquid crystal display element LD1 of the non-flat form described above can be used as, e.g., a display element of a mobile telephone. FIG. 15 shows an example of the mobile telephone employing the non-flat liquid crystal display element LD1. In the mobile telephone shown in FIG. 15, the non-flat liquid crystal display element LD1 provides a display screen in a substantially whole region of a predetermined surface of the mobile telephone. For example, information such as communication information and operation information may be displayed on the first flat region of the non-flat liquid crystal display element LD1, and a software-keypad (image displayed by the display element LD1 to provide a keypad) 91 including a ten keypad, a communication keypad and others may be usually displayed on the second flat region. When necessary, the display regions are entirely used for displaying communication information such as an e-mail text and image.

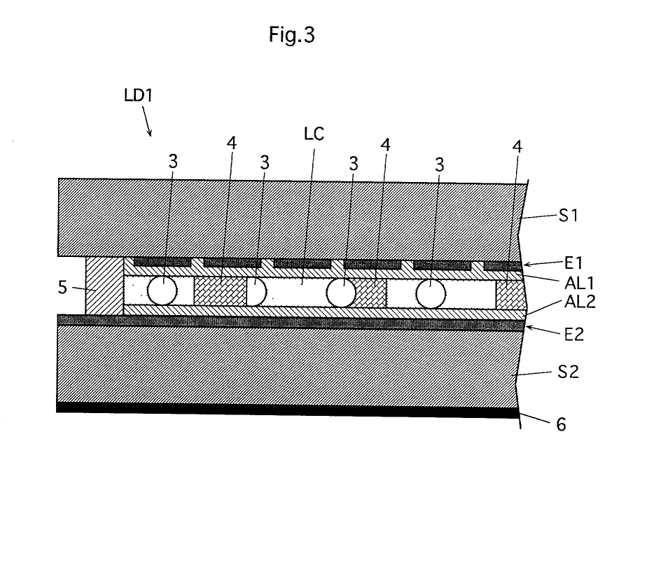

The non-flat liquid crystal display element LD1 is shown more specifically in a cross section of FIG. 3. FIG. 3 is a cross section showing a portion (left end portion in FIG. 2(B)) of the non-flat liquid crystal display element LD1.

A liquid crystal LC is disposed between the substrates S1 and S2. A sealing wall 5 is arranged in a position surrounding the liquid crystal LC between the substrates for preventing leakage of the liquid crystal from the space between the substrates.

Each the substrates S1 and S2 in this embodiment is a polycarbonate film of 0.2 mm in thickness.

Electrodes E1 and E2 are formed on the substrates S1 and S2 for simple matrix drive, respectively. The electrodes E1 and E2 in this embodiment are made of ITO. The electrodes E1 and E2 are not shown in the figures except for FIG. 3.

The electrode E1 on the substrate S1 is composed of a plurality of parallel belt-like electrodes arranged at a predetermined pitch. Although not shown, the electrode E2 on the substrate S2 is similar to the electrode E1, and is composed of a plurality of parallel belt-like electrodes arranged at a predetermined pitch.

The belt-like electrodes of the electrode E1 extend in the direction Y, and the belt-like electrodes of the electrode E2 extend in the direction X perpendicular to the direction Y. Thus, these belt-like electrodes form a so-called matrix structure.

Each of the belt-like electrodes of the electrode E1 in this embodiment has a width, which is constant in both the flat and curved regions. Likewise, each of the belt-like electrodes of the electrode E2 in this embodiment has a width, which is constant in both the flat and curved regions.

In each of the electrodes E1 and E2 in this embodiment, the belt-like electrodes are equally spaced from each other at a pitch of 300 μm in this embodiment.

Orientation films AL1 and AL2 are formed on the electrodes E1 and E2, respectively. The orientation films AL1 and AL2 are not shown in the figures except for FIG. 3. The orientation films AL1 and AL2 in this embodiment are made of an orientation film material AL8044 (manufactured by JSR Corp.) . The liquid crystal LC disposed between the substrates is in contact with the orientation films AL1 and AL2.

The liquid crystal LC in this embodiment is a chiral nematic liquid crystal containing a nematic liquid crystal and a chiral agent added thereto. The chiral nematic liquid crystal exhibits a cholesteric phase at a room temperature, and selectively reflects the light of a predetermined wavelength. In this embodiment, the liquid crystal LC has the selective reflection wavelength in the green region.

Contents displayed on the non-flat liquid crystal display element LD1 are viewed from the upper side of the substrate S1 in FIGS. 2(B) and 3. A black light absorber layer 6 is arranged, as shown in FIG. 3, on the backside of the substrate S2, which is remote from the observation side. The light absorber layer 6 is not shown in the figures except for FIG. 3. The support member 7 is adhered to this light absorber layer 6.

In the non-flat liquid crystal display element LD1, a plurality of spacers 3 are disposed between the substrates S1 and S2 for controlling the gap between the substrates, and thus for controlling the thickness of the liquid crystal LC. The spacers 3 are not shown in FIG. 1. The spacers 3 are arranged in a region surrounded by the sealing wall 5. The spacers 3 in this embodiment are fixing-type spacers N3M14 (manufactured by Ube Nitto Kasei Kogyo Corp.) each made of thermoplastic resin and having a particle diameter of 7 μm.

A plurality of resin structures 4 are disposed between the substrates S1 and S2, and are adhered to each of the substrates S1 and S2. The resin structures 4 are not shown in the figures other than FIG. 3. The resin structure 4 in this embodiment is made of polyester resin PES-360S30 (manufactured by Three Bond Corp.).

Each of the resin structure 4 in this embodiment has a columnar form, and has top and bottom surfaces adhered to the substrates S1 and S2, respectively. In this embodiment, each of the resin structures 4 located in each of the curved and flat regions has a diameter of about 40 μm. The pitch of the resin structures in each region is equal to 800 μm.

In the non-flat liquid crystal display element LD1, a spacer density (i.e., the number of the spacer(s) per unit area of the substrate) in each region of the display element in accordance with the curvature of the region and others in the following way, which will be described with reference to FIGS. 2(A) and 2(B).

The spacer densities in the curved region, in the boundary region between the curved region and the first flat region, and in the boundary region between the curved region and the second region is larger than the spacer density in the flat region except for the boundary with any other region.

In other words, the spacer densities (a) in the boundary region R1 between the first flat region and the curved region (i.e., in the region composed of a region portion R4, near the curved region, of the first flat region and a region portion R5, near the first flat region, of the curved region), (b) in a region portion R6, remote from the first and second flat regions, of the curved region, and (c) in the boundary region R2 between the second flat region and the curved region (i.e., in the region composed of a region portion R7, near the second flat region, of the curved region and a region portion R8, near the curved region, of the second flat region) are larger than those (d) in a region portion R3, remote from the curved region, of the first flat region and (e) in a region portion R9, remote from the curved region, of the second flat region.

In this embodiment, the spacer densities in the curved region and the boundary region are equal to about 800 pcs/mm², and the spacer density in the each of the flat regions except for the boundary with any other region is equal to about 300 pcs/mm² (see FIG. 2(A)).

By changing the spacer densities in accordance with the curvatures of the respective regions and others, the non-flat liquid crystal display element LD1 can achieve the following advantages.

As will be described later in greater detail, the non-flat liquid crystal display element LD1 is produced in such a manner that a liquid crystal display element of a flat form is first produced, and then is deformed into the predetermined or intended non-flat form to provide the non-flat liquid crystal display element LD1.

In the non-flat liquid crystal display element LD1, therefore, a force acting to return a curved surface into a flat surface is applied to the curved region as well as the boundary regions between the curved and flat regions. This force acts to lower the uniformity in gap between the substrates throughout the liquid crystal display element LD1.

In the non-flat liquid crystal display element LD1, however, the spacer densities are high in the curved region and in the boundary regions between the curved and flat regions as already described so that the uniformity in gap between the substrates can be improved in these regions. The spacer density is not increased in all the regions, and is increased only locally so that the uniformity in gap between the substrates can be increased without wasting the spacers. Accordingly, the uniformity in gap between the substrates can be improved throughout the non-flat liquid crystal display element, and the uniformity in liquid crystal thickness can be improved throughout non-flat liquid crystal display element LD1. Thereby, the non-flat liquid crystal display element LD1 can perform good display without irregularity in displayed color.

§6.

Description will now be given on the method of producing the non-flat liquid crystal display element LD1.

According to the producing method, a liquid crystal display element, which is entirely flat, is first formed, and then is deformed into an intended non-flat form so that the non-flat liquid crystal display element LD1 is produced. The following producing method for producing the non-flat liquid crystal display element LD1 can also be applied to production of non-flat liquid crystal display elements LD2-LD9, which will be described later.

Detailed description will now be given on a flat element forming step of forming the entirely flat liquid crystal display element and a deforming step of deforming the flat liquid crystal display element into a non-flat form.

(a) Flat Element Forming Step

The flat element forming step is performed to produce the flat liquid crystal display element, which has the same internal structure as the final non-flat liquid crystal display element except for the whole form.

First, the pair of substrates S1 and S2 are prepared. Each of the substrates S1 and S2 prepared in this step has a flat form.

The electrode E1 composed of the belt-like electrodes and the orientation film AL1 are successively formed on the substrate S1. For example, a conductive film (ITO film in this example) is uniformly formed on the substrate S1, and then is etched into a predetermined form, e.g., in a photolithography method so that the electrode E1 composed of the plurality of belt-like electrodes can be formed. The orientation film AL1 can be formed, e.g., in the spin coat method. Since the substrate S1 is flat during the above step, conventional manners and devices can be used for forming the electrode E1 and the orientation film AL1.

On one of the surfaces of the substrate S2, the electrode E2 and the orientation film AL2 are successively formed in a similar manner. The black light absorber layer 6 is formed on the other surface of the substrate S2. For example, the light absorber layer 6 may be formed by applying black paint over the substrate S2.

Then, the sealing wall 5 is formed on one of the substrates S1 and S2. In this example, the liquid crystal will be filled into a space between the substrates in a vacuum filling method. For this, the sealing wall 5 with a liquid crystal inlet is formed. The sealing wall 5 may be made of resin such as UV-setting resin or thermosetting resin. The sealing wall 5 in this example is made of polyester resin.

Then, the resin structures 4 are formed on one of the substrates S1 and S2. The resin structures 4 are formed on the substrate in the predetermined form and size, and arrangement pitch.

Then, the spacers are dispersed on one of the substrates S1 and S2.

As already described, the spacer density in the non-flat liquid crystal display element LD1 is different in the respective regions so that the spacers are dispersed on the substrate to achieve the predetermined density in each region. The dispersion of the spacers is performed to achieve the spacer density of 800 pcs/mm² in regions which will be, after performing the deforming step, the curved region as well as the boundary regions between the curved region and the flat regions, and to achieve the spacer density of 300 pcs/mm² in the region other than those regions. For example, the spacers may be dispersed on the substrate through a mask, which is provided with an aperture at a portion corresponding to the region of the density of 800 pcs/mm². Thereby, the spacers can be dispersed on the predetermined region at the density of 800 pcs/mm². The spacers may be dispersed in a similar manner on the region where the spacers are to be disposed at the density of 300 pcs/mm².

The sealing wall forming step, the spacer dispersing step and the resin structure forming step described above may be performed in any order.

Then, the substrates S1 and S2 are joined together to have an entirely flat form. This joining is performed on a flat surface of, e.g., a flat table, and is performed such that the belt-like electrodes of the electrode E1 on the substrate S1 are perpendicular to the belt-like electrodes of the electrode E2 on the substrate S2. For example, a heating roller or the like is used to apply a heat and a pressure while overlaying the substrates S1 and S2 with each other. Thereby, the sealing wall 5 and the resin structures 4 are adhered to the substrates S1 and S2 so that the substrates are joined and fixed together.

Thereafter, the liquid crystal LC is filled into the space surrounded by the sealing wall 5 and substrates through the inlet provided at the sealing wall 5 in a vacuum filling method. After the filling of the liquid crystal, the liquid crystal inlet provided at the sealing wall 5 is closed with a sealing material. In this example, the sealing material closing the liquid crystal inlet is made of UV-setting resin Photolec A-704-60 (manufactured by Sekisui Finechemical Corp.).

Through these steps, the flat liquid crystal display element entirely having a flat form is completed.

(b) Deforming Step

The flat liquid crystal display element thus prepared is deformed into the intended or predetermined non-flat form shown in FIG. 1.

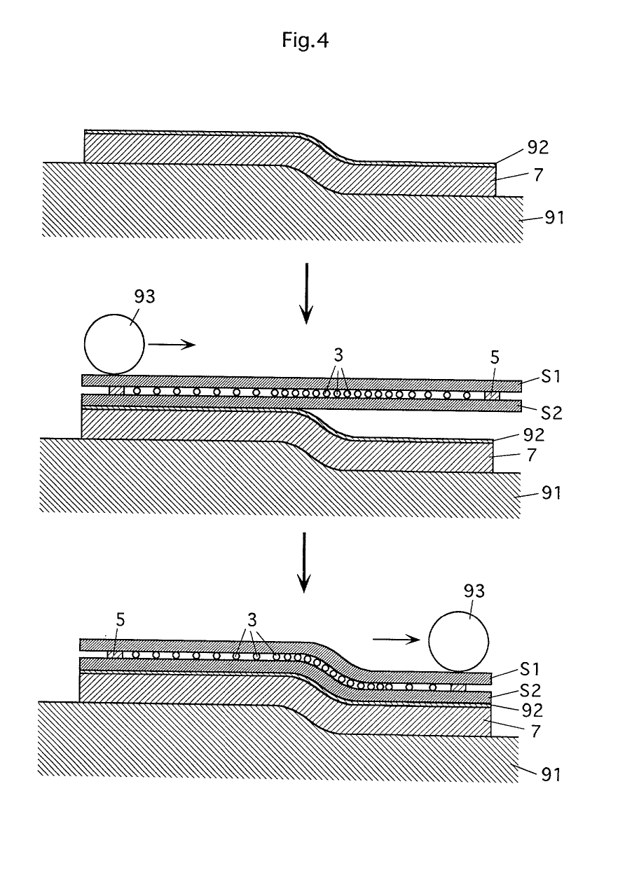

In this example, the flat liquid crystal display element is deformed into the intended non-flat form in the following manner, which will be described with reference to FIG. 4.

First, the support member 7 is fixed to a table 91 having a surface complementary in shape with the support member 7. As described above, the support member 7 has the surface complementary in shape with the intended form of the non-flat liquid crystal display element LD1 shown in FIG. 1. Air suction may be performed to fix the support member 7 onto the table 91.

Then, an adhesive sheet 92 is fixed to the support member 7.

Thereafter, the flat liquid crystal display element is laid on the adhesive sheet 7, and is pressed thereto by a roller 93 moving from one end portion of the display element to the other end portion. Thereby, the display element is adhered to the support member 7 via the adhesive sheet 92 so that the liquid crystal display element is curved into the intended form extending along the surface of the support member 7.

Through the above steps, the non-flat liquid crystal display element LD1 of the non-flat form shown in FIG. 1 is produced.

According to the producing method described above, the flat element forming step can be executed to produce the flat liquid crystal display element by using the known conventional manners and devices.

By the way, the liquid crystal display element LD1 of the non-flat form shown in FIG. 1 could be produced using two substrates that have the finally intended non-flat forms from beginning. In the method using such substrates, however, operations such as formation of the electrodes, orientation films and others, dispersion of the spacers, formation of the resin structures and formation of the sealing wall would be difficult because these operations must be effected on the non-flat substrates. Because of the same reason, transportation and cleaning of the non-flat substrates would be also difficult. For these operations, some steps would require devices other than those used for producing the flat liquid crystal display element.

Accordingly, the producing method, in which the flat liquid crystal display element is first produced, can efficiently produce the non-flat liquid crystal display element. As a result, the non-flat liquid crystal display element produced by the producing method described above can be inexpensive.

If the non-flat liquid crystal display element LD1 is produced such that the flat liquid crystal display element is firstly produced, and then is deformed into the non-flat form (curved form in this example), the curved region as well as the boundary regions between the curved and flat regions are liable to receive a force acting to return the form into a flat form. However, these regions in the liquid crystal display element LD1 has the higher spacer density than the other region, as already described. Therefore, the liquid crystal thickness can be uniform throughout the display element.

According to the method of producing the non-flat liquid crystal display element described above, even in the case where the non-flat liquid crystal display elements having different non-flat forms are to be produced, the steps for forming the flat display elements can be performed in the same way. Accordingly, the non-flat liquid crystal display elements having different forms can be produced efficiently.

§7.

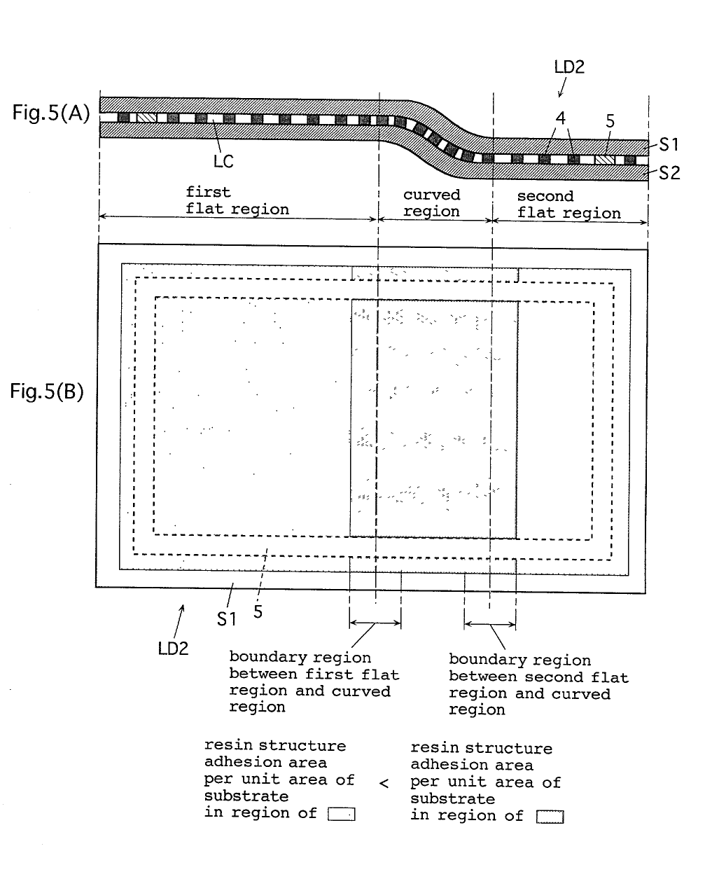

Another example of the non-flat liquid crystal display element is shown in FIGS. 5(A) and 5(B), which are a schematic cross section and a schematic plan, respectively.

A non-flat liquid crystal display element LD2 shown in FIG. 5 has the same form and the same inner structure as the non-flat liquid crystal display element LD1 shown in FIG. 1 except for the followings.

In the non-flat liquid crystal display element LD2, the spacer density in each of the flat and curved regions is constant, and is equal to 400 pcs/mm² in this example.

In the non-flat liquid crystal display element LD2, as shown in FIG. 5(B), an adhesion area, per unit area of the substrate, of the resin structure(s) 4 with respect to the substrate is determined such that the adhesion area in the curved region as well as the adhesion area in the boundary regions between the curved and flat regions are larger than that in the other region. The resin structures 4 are formed not only in the region inside the sealing wall 5 but also in the region outside the sealing wall 5.

In this example, the adhesion area of each resin structure 4 with respect to the substrate is constant in all the regions. The pitch of the resin structures in the curved region as well as in the boundary regions between the curved and flat regions is smaller than that in the other region, so that the number of the resin structures in these curved and boundary regions is larger than that in the other region. Thereby, the resin structure adhesion area, per unit area of the substrate, of the resin structures with respect to the substrates in the above curved and boundary regions is larger than that in the other region. The resin structure adhesion area, per unit area of the substrate, with respect to the substrate may be increased by increasing the adhesion area of each resin structure with respect to the substrate.

In the non-flat liquid crystal display element LD2, the resin structure adhesion area, per unit area of the substrate, with respect to the substrates is large in the curved region as well as the boundary regions between the curved and flat regions so that the adhesion force of the total resin structures with respect to the substrates is high in these regions. Accordingly, it is possible to suppress the disengagement of the resin structures 4 from the substrates S1 and S2 even when these regions are subjected to the force acting to return these regions into a flat form as well as a force acting to shift the positions of the substrates S1 and S2 from each other. Therefore, it is possible to suppress disengagement of the sealing wall 5 from the substrates S1 and S2 in these regions, and therefore leakage of the liquid crystal can be suppressed. The resin structures 4 also have a function of keeping the gap between the substrates, similarly to the spacer 3, and therefore can serve to suppress the irregularities in gap. This also allows good display.

In the non-flat liquid crystal display element LD2, the spacer density in the curved region as well as the boundary regions between the curved and flat regions may be larger than that in the other region, similarly to the non-flat liquid crystal display element LD1. This can further increase the uniformity in gap between the substrates.

§8.

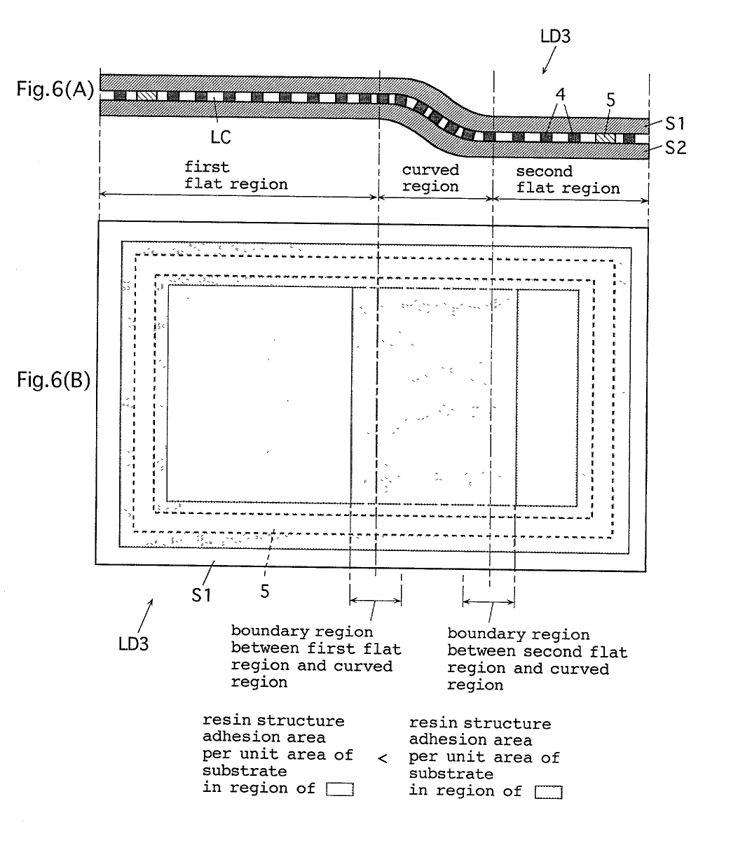

Further another example of the non-flat liquid crystal display element is shown in FIGS. 6(A) and 6(B), which are a schematic cross section and a schematic plan, respectively.

A non-flat liquid crystal display element LD3 shown in FIGS. 6(A) and 6(B) has the same form and internal structure as the non-flat liquid crystal display element LD2 shown in FIGS. 5(A) and 5(B) except for the followings.

In the non-flat liquid crystal display element LD3, the resin structure adhesion area, per unit area of the substrate, with respect to the substrate is determined such that the adhesion area in the curved region as well as the adhesion area in the boundary regions between the curved and flat regions, and further the adhesion area in a region near the sealing wall 5 are larger than that in the other region.

By increasing the adhesion area of the resin structures 4 with respect to the substrate per unit area of the substrate in the region near the sealing wall 5, it is possible to suppress disengagement of the sealing wall 5 from the substrates S1 and S2 more efficiently. Since disengagement of the sealing wall 5 from the substrates can be suppressed without requiring the large adhesion area of the sealing wall 5 with respect to the substrates, a frame size of the non-flat liquid crystal display element LD3 does not increase. This allows a compact structure of the non-flat liquid crystal display element LD3.

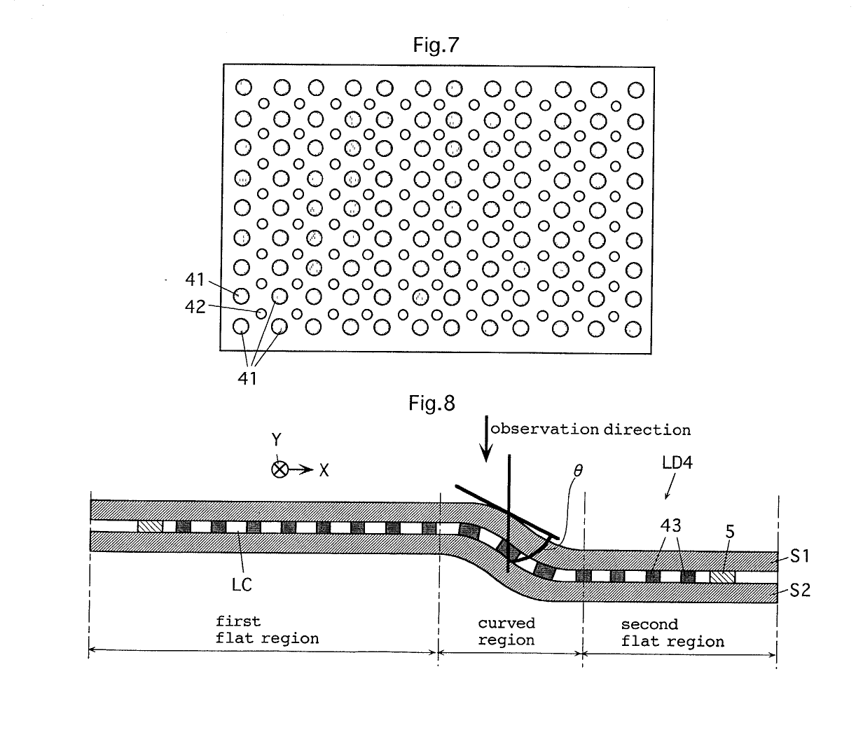

The resin structures may be arranged as shown in FIG. 7 so that the resin structure adhesion area, per unit area of the substrate, with respect to the substrate in the region near the sealing wall 5 may be larger than that in the other region. FIG. 7 shows an arrangement of the resin structures in the region near the sealing wall 5. The region near the sealing wall 5 is provided with resin structures 41, which are also disposed in a region portion, remote from the sealing wall 5, of the flat region except for the boundary with any other region. The region near the sealing wall 5 is further provided with resin structures 42 each located in a central position among the neighboring four resin structures 41. Adhesion surfaces of the resin structures 41 and 42 adhered to the substrates are circular and have diameters of 80 μm and 40 μm, respectively. The pitch of the resin structures 41 is equal to 800 μm. The pitch of the resin structures 42 is also equal to 800 μm.

In this example, the resin structure adhesion area, per unit area of the substrate, with respect to the substrates in the region near the sealing wall portion located in the region portion, remote from the curved region, of the flat region is equal to that in the regions near the sealing wall portions located in the curved region and the boundary region. However, the latter may be larger or smaller than the former. These relationships are not particularly restricted.

§9.

Further another example of the non-flat liquid crystal display element is shown in FIG. 8, which is a schematic cross section.

A non-flat liquid crystal display element LD4 in FIG. 8 has the same form and internal structure as the non-flat liquid crystal display element LD1 in FIG. 1 except for the followings.

In the non-flat liquid crystal display element LD4, the density of the spacers 3 disposed between the substrates is equal to about 400 pcs/mm² in both the curved and flat regions.

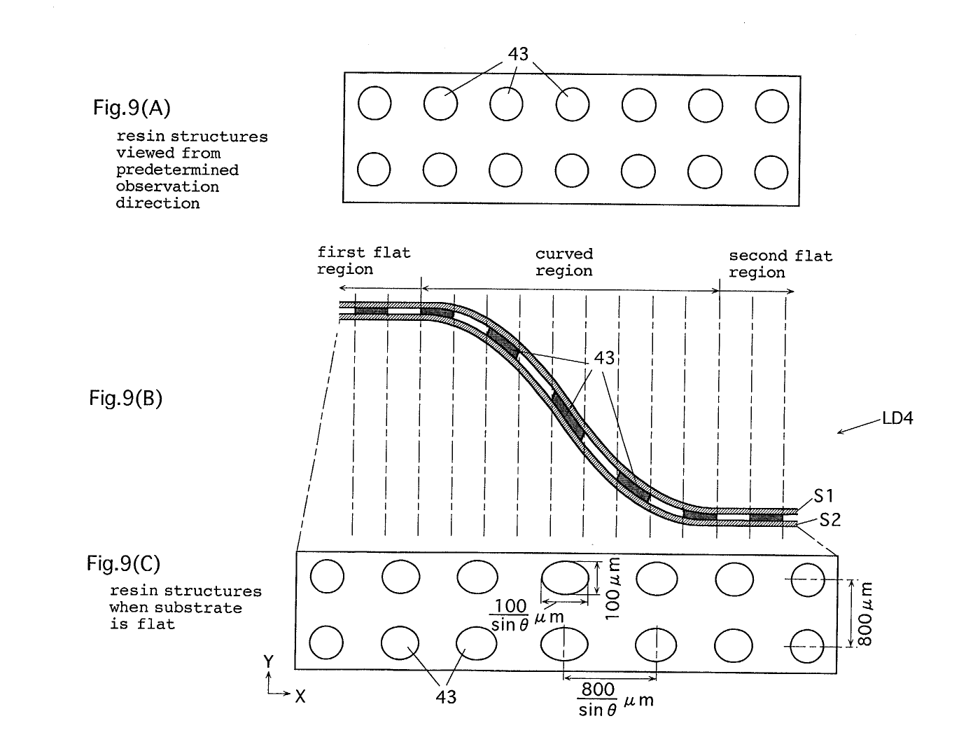

In the non-flat liquid crystal display element LD4, form, size and pitch of resin structures 43 are different in the respective regions in the following way, which will be described with reference to FIGS. 9(B) and 9(C). FIG. 9(B) is a schematic cross section of a portion of the display element LD4 near the curved region. FIG. 9(C) shows the forms of the resin structures 43 and others when the liquid crystal display element LD4 is in the flat form.

In each of the regions, the adhesion surfaces of the resin structures with respect to the substrate have elliptical forms (including circular forms), respectively, and each has a diameter (axial width) of 100 μm in the direction Y (along which the display element has no curvature) as well as a diameter of (100/sin θ) μm in the direction X (along which the display element has curvature). In each of the regions, the arrangement pitch of the resin structures is equal to 800 μm in the direction Y, and is equal to (800/sin θ) μm in the direction X.

The angle θ of a certain region (refer to third region) is defined, as shown in FIG. 8, between a predetermined observation direction and a plane parallel to the surface of the third region (a plane parallel to a tangential surface of the third region if the third region surface is curved). The observation direction in this example is equal to the direction of normal of the first flat region (and thus is equal to the direction of the normal of the second flat region). The angle θ depends on the angle defined between the direction of the normal of the surface of the region and the predetermined observation direction.

Since the angle θ is equal to 90 degrees in the flat region, the resin structure in the flat region has the diameters of 100 μm in both the directions X and Y. Thus, the resin structure in the flat region is adhered to the substrate through the circular adhesion surface. Further, the resin structures in the flat region are arranged at the pitches of 800 μm in both the directions X and Y.

By changing the form, size and pitch of the resin structures in accordance with the angle θ of each region, if the resin structures are projected onto the plane perpendicular to the predetermined observation direction, the resin structures appear the same form, size and pitch in all the regions.

Accordingly, as shown in FIG. 9(A), when viewed in the predetermined observation direction, which is perpendicular to the flat regions in this example, the form, size and pitch of the resin structures 43 in all the regions can appear same even if the resin structure 43 has a substantially visible size. In the non-flat liquid crystal display element LD4, all the resin structures have the substantially visible size. When viewed in a direction somewhat shifted from the predetermined observation direction, which is perpendicular to the flat regions in this example, the resin structures 43 in all the regions can appear substantially same form, size and pitch. Thereby, it is possible to suppress the influence exerted by the resin structures 43 on the displayed image by the non-flat liquid crystal display element LD4. If the appearance of the resin structure form, size and/or pitch is not same in the respective regions, the observer's viewing of the displayed image or content is interfered by the resin structures. Thus, the same appearance of the resin structures in all the regions allows natural display by the non-flat liquid crystal display element LD4 for the viewer or observer without interference.

Similarly to the non-flat liquid crystal display element LD1 already described, the non-flat liquid crystal display element LD4 is produced by preparing the flat liquid crystal display element and then curving it. In the non-flat liquid crystal display element LD4, the pitch of the resin structures, located in the curved region in the direction X, is larger than that in the flat region. Therefore, as compared with the case where the resin structures are arranged at a constant pitch in all the regions, a smaller force acts to return the liquid crystal display element into a flat form when curving the flat liquid crystal display element. This allows easy production of the non-flat liquid crystal display element LD4.

§10.

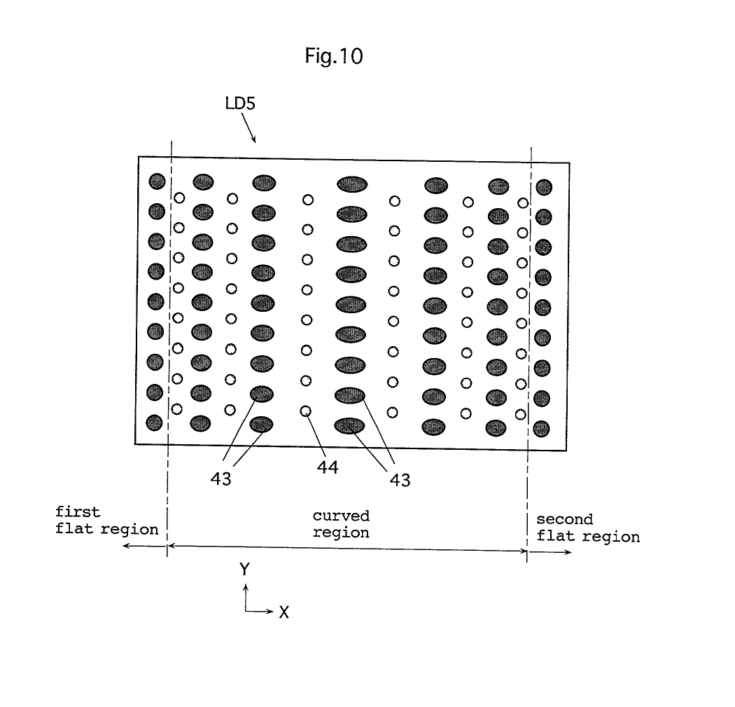

FIG. 10 shows arrangement pattern of the resin structures near the curved region of further another example of the non-flat liquid crystal display element.

A non-flat liquid crystal display element LD5 shown in FIG. 10 has the same form and internal structure as the non-flat liquid crystal display element LD4 shown in FIG. 9 except for the followings.

The non-flat liquid crystal display element LD5 shown in FIG. 10 is provided with the resin structures 43, which are the same as those arranged between the substrates in the non-flat liquid crystal display element LD4, and is further provided with resin structures 44 at the curved region and at the boundary regions between the curved and flat regions.

The resin structures 44 are arranged in the following positions. Each resin structure 44 is located at a center among the neighboring four resin structures 43. Contact surface of each resin structure 44 with the substrate is a circular surface of 30 μm in diameter. The resin structures 43 in the non-flat liquid crystal display element LD5 have different form, size and pitch in the respective regions in accordance with the angle θ of each region, similarly to the resin structures in the non-flat liquid crystal display element LD4.

By additionally arranging the resin structures 44 between the substrates, the resin structure adhesion area, per unit area of the substrate, with respect to the substrate in the curved region as well as the boundary regions between the curved and flat regions can be larger than that in the flat region except for the boundary with the other region. Compared with the non-flat liquid crystal display element LD4, the non-flat liquid crystal display element LD5 can provide the larger adhesion area, per unit area of the substrate, of the resin structures with respect to the substrate in the curved region as well as the boundary regions between the curved and flat regions. Accordingly, the non-flat liquid crystal display element LD5 can more efficiently suppress disengagement of the resin structures 43 and 44 from the substrates in the curved region as well as the boundary regions between the curved and flat regions. This can further suppress breakage of the sealing wall 5.

The resin structure 44 additionally arranged in the non-flat liquid crystal display element LD5 is smaller than the visible size. Therefore, the resin structures 44 does not lower the visibility of the displayed image by the non-flat liquid crystal display element LD5 even if the form, size and pitch of the resin structures 44 are not intentionally changed in accordance with the angle θ.

In summary, the form, size and pitch of the resin structures having the visible size may be changed in accordance with the angle θ, similarly to the non-flat liquid crystal display element LD4, and thereby the lowering of the visibility can be suppressed.

§11.

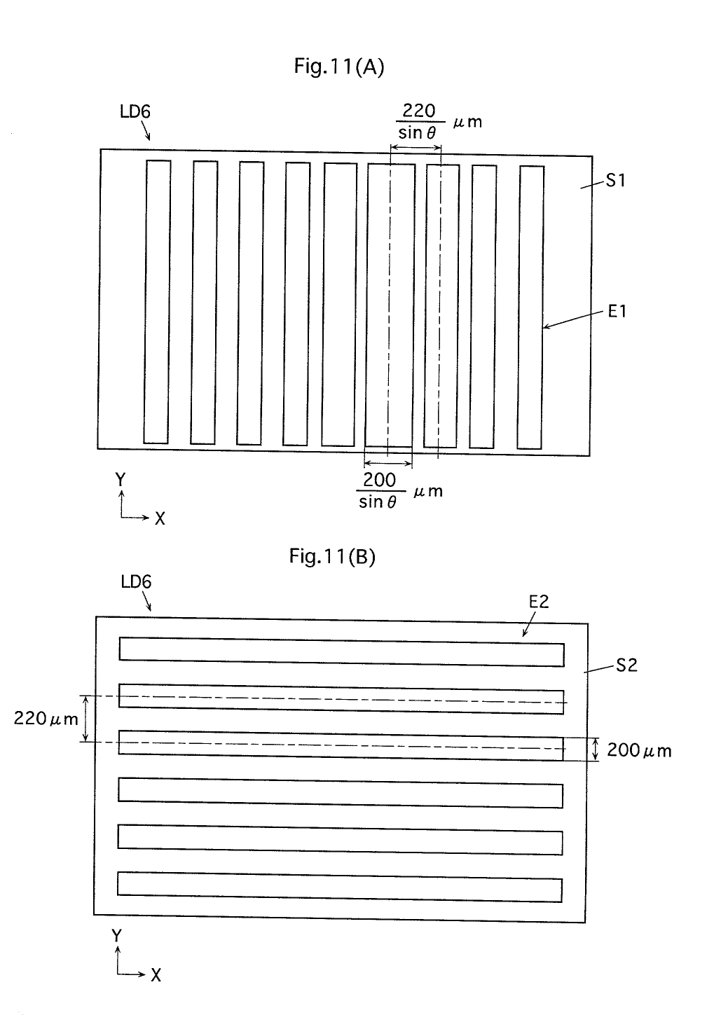

FIGS. 11(A) and 11(B) show the forms and others of the electrodes formed on the two substrates in further another example of the non-flat liquid crystal display element.

A non-flat liquid crystal display element LD6 shown in FIGS. 11(A) and 11(B) has the same form and internal structure as the non-flat liquid crystal display element LD1 shown in FIG. 1 except for the followings.

In the non-flat liquid crystal display element LD6, the spacers 3 are disposed at a constant density of 400 pcs/mm² in all the regions. In all the regions, the resin structure 4 has a columnar form of 100 μm in diameter, and the pitch of these resin structures 4 is equal to 800 μm.

In the non-flat liquid crystal display element LD6, the width and pitch of the belt-like electrodes forming the electrodes E1 and E2 are different depending on the regions as described below.

In the non-flat liquid crystal display element LD6, as shown in FIG. 11(B), each of the belt-like electrodes of the electrode E2, which is formed on the substrate S2 and extends in the direction X, has a width of 200 μm and has a center spaced by 220 μm from the center of the neighboring electrode (i.e., the pitch is 220 μm), which are the same as those in the non-flat liquid crystal display element LD1.

As shown in FIG. 11(A), each of the belt-like electrodes of the electrode E1, which is formed on the substrate S1 and extends in the direction Y, has a width of (200/sin θ) μm, and these belt-like electrodes are arranged at a pitch of (220/sin θ) μm.

The angle θ is defined similarly to the angle θ (see FIG. 8) in the non-flat liquid crystal display element LD4 already described, and thus is defined between the plane parallel to the region carrying the belt-like electrode and the predetermined observation direction. The observation direction in this example is perpendicular to the first flat region, and thus is perpendicular to the second flat region.

By changing the width and pitch of the belt-like electrodes of the electrode E1 in accordance with the angle θ so that the respective belt-like electrodes of the electrode E1 can be projected onto the plane perpendicular to the observation direction (onto the plane parallel to the flat region) to appear the same form, size and pitch.

Accordingly, when viewed from the predetermined observation direction, which is perpendicular to the flat region in this example, the pixels in all the regions appear substantially same form, size and pitch. Thus, when the image displayed by the non-flat liquid crystal display element LD6 is viewed from the predetermined observation direction (which is perpendicular to the flat region in this example), distortion hardly occurs in the displayed image in spite of the fact that the display element LD6 has the curved region. When the image displayed by the non-flat liquid crystal display element LD6 is viewed in a direction somewhat shifted from the predetermined observation direction (which is perpendicular to the flat region in this example), distortion in the displayed image can be smaller than that by the non-flat liquid crystal display element LD1.

In the non-flat liquid crystal display element LD6 shown in FIGS. 11(A) and 11(B), the form, size and pitch of the pixels in the respective regions are changed in accordance with the angle θ of each region so that the pixel form, size and pitch in all the regions can be appeared same when viewed from the predetermined observation direction (which is perpendicular to the flat region in this example). More specifically, the width and pitch of the belt-like electrodes of the electrode E1 are changed in accordance with the angle θ for changing the form, size and pitch of the pixels in the respective regions in accordance with the angle θ of each region.

The above manner for suppressing the distortion in the displayed image can be applied not only to the non-flat liquid crystal display element of the simple matrix drive type but also to the non-flat liquid crystal display element of the active matrix drive type.

In each of the embodiments described above, respective portions of the curved region located between the first and second flat regions are handled equally. In stead of this, a concavely curved region portion and a convexly curved region portion of the curved region may have different spacer densities, different resin structure adhesion areas, sizes, forms and/or arrangement pitches, and/or different pixel forms, sizes and/or arrangement pitches so that these parameters may be optimum in the concavely curved region portion and the convexly curved region portion.

§12.

The various structures, manners and others described above can be applied not only to the non-flat liquid crystal display element having the entire form shown in FIG. 1 but also to the non-flat liquid crystal display elements of various forms to achieve similar effects.

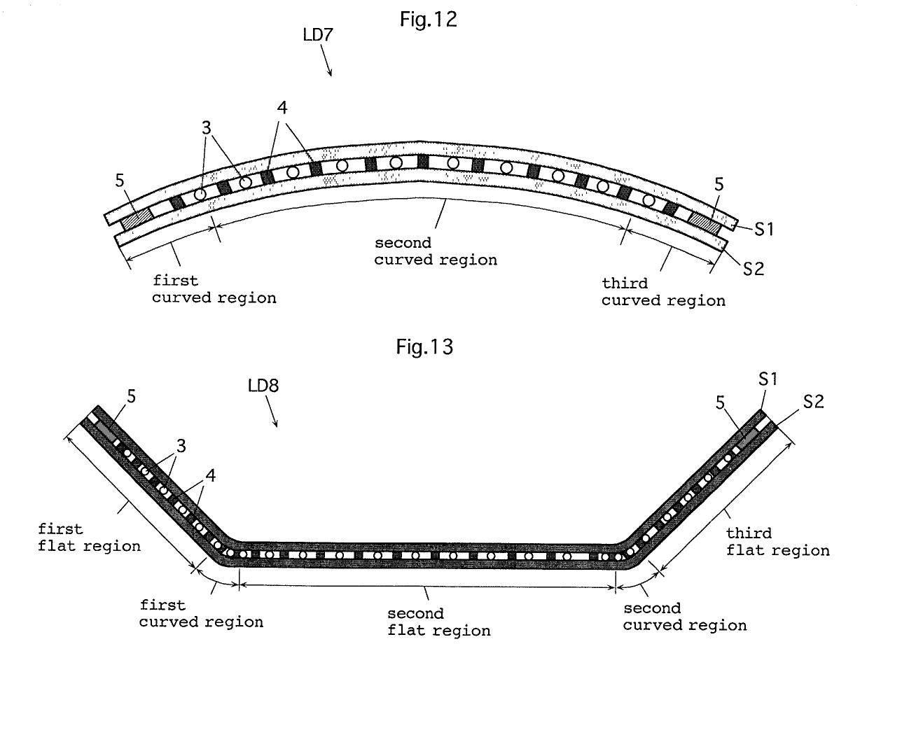

The various structures, manners and others described above may be applied to a non-flat liquid crystal display element LD7 having a whole form shown in FIG. 12. The non-flat liquid crystal display element LD7 has first, second and third curved regions neighboring in this order. The first and third curved regions have curvatures different from that of the second curved region. The second curved region has the larger curvature.

The various structures, manners and others described above may be applied to a non-flat liquid crystal display element LD8 having a whole form shown in FIG. 13. The non-flat liquid crystal display element LD8 has first, second and third flat regions as well as first and second curved regions. The normals of the first, second and third regions extend in different directions, respectively. The first curved region is located between the first and second flat regions for smoothly connecting these flat regions having the normals of different directions. Likewise, the second curved region is located between the second and third flat regions for smoothly connecting these flat regions having the normals of different directions.

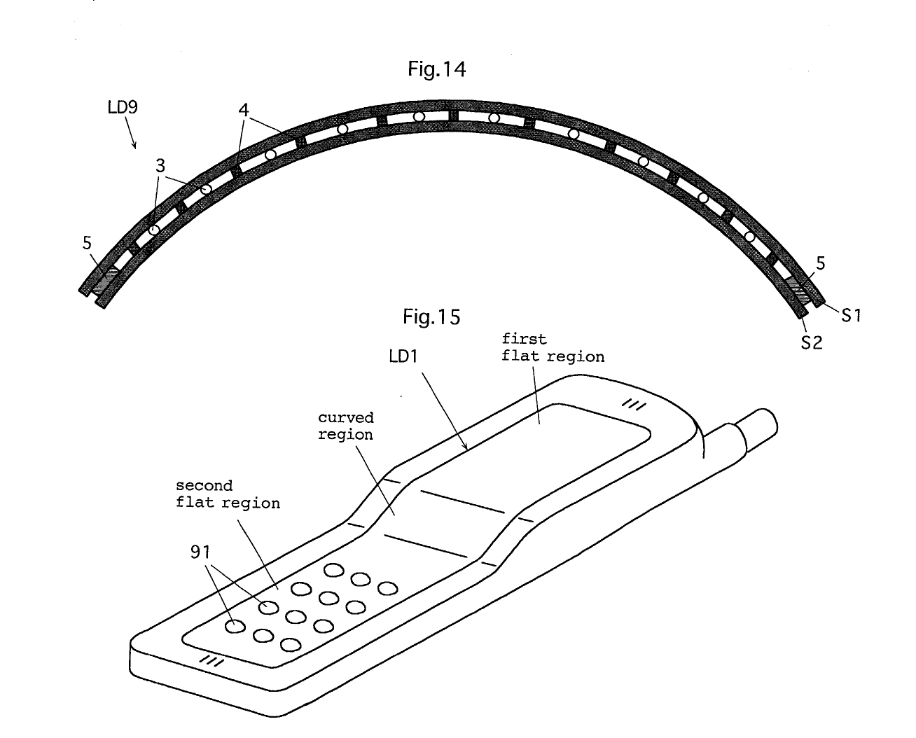

The various structures, manners and others described above may be applied to a non-flat liquid crystal display element LD9 having a whole form shown in FIG. 14. The non-flat liquid crystal display element LD9 entirely has a curved form of a single curvature.

Similarly to the examples already described, the non-flat liquid crystal display elements LD7 and LD8 may be configured, e.g., such that the spacer density in the region of a large curvature is larger than that in the region of a small curvature. Thereby, it is possible to increase the uniformity in gap between the substrates in the whole non-flat liquid crystal display element. The spacer density may be increased in the boundary region between the neighboring two regions having different (i.e., large and small) curvatures. This further increases the uniformity in gap between the substrates in the whole non-flat liquid crystal display element.

In the non-flat liquid crystal display elements LD7 and LD8, the resin structure adhesion area, per unit area of the substrate, with respect to the substrate in the region of a large curvature may be larger than that in the region of a small curvature, whereby it is possible to suppress the disengagement of the resin structures 4 from the substrates S1 and S2, and the uniformity in gap between the substrates can be increased throughout the non-flat liquid crystal display element. In the boundary region between the two neighboring regions of the different curvatures, the resin structure adhesion area, per unit area of the substrate, with respect to the substrate may be large, whereby disengagement of the resin structures 4 from the substrates can be further suppressed. The resin structure adhesion area, per unit area of the substrate, of the resin structures 4 with respect to the substrates may be large in the region near the sealing wall 5, whereby the disengagement of the sealing wall 5 from the substrates can be further suppressed.

In the non-flat liquid crystal display element LD9, the density of spacers 3 may be large in the top portion of the curved region and/or in the region near the sealing wall 5, whereby it is possible to further increase the uniformity in gap between the substrates throughout the non-flat liquid crystal display element. The resin structure adhesion area, per unit area of the substrate, with respect to the substrates may be large in the region near the sealing wall 5 and/or in the top portion of the curved region, whereby the disengagement of the sealing wall from the substrates can be further suppressed.

In any one of the non-flat liquid crystal display elements, at least one of the form of the adhesion surface of the resin structure 4 with respect to the substrate, the size of the above adhesion surface and the arrangement pitch of the resin structures 4 may be changed in accordance with the angle between the predetermined observation direction and the normal direction of each region so that no difference or only a small difference occurs in these factor(s) between the respective regions when the resin structures are viewed from the predetermined observation direction. Thereby, it is possible to suppress the influence exerted on the observation by the resin structures 4 when viewing the displayed contents of the non-flat liquid crystal display element from the predetermined observation direction.

In any one of the non-flat liquid crystal display elements, at least one of the pixel form, size and arrangement pitch may be changed in accordance with the angle between the predetermined observation direction and the normal direction of each region so that no difference or only a small difference occurs between the respective regions when the pixels are viewed from the predetermined observation direction. Thereby, it is possible to suppress the display distortion when viewing the displayed contents of the non-flat liquid crystal display element from the predetermined observation direction.

Two or more of the structures, manners and others employed in the non-flat liquid crystal display elements LD1-LD9 described above may be employed in combination.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A liquid crystal display element comprising:
a pair of substrates;
a liquid crystal disposed between the substrates;
a plurality of spacers disposed between the substrates; and
a sealing wall disposed between the substrates and surrounding the liquid crystal, wherein
the substrates are spaced from each other by a constant distance kept by the spacers, and are opposed to each other such that a major surface of the liquid crystal display element has a non-flat form, and
a spacer density in a predetermined region of the liquid crystal display element is different from that in at least a portion of the other region.

2. A liquid crystal display element according to claim 1, wherein
the liquid crystal display element has a plurality of regions having different curvatures, and
the spacer density in the region of a large curvature is larger than that in the region of a small curvature.

3. A liquid crystal display element according to claim 1, wherein
the liquid crystal display element has a first curved region and a second region neighboring the first curved region and having a smaller curvature than the first curved region, and
the spacer density in the first curved region except for a boundary with any other region is larger than that in the second region except for a boundary with any other region.

4. A liquid crystal display element according to claim 3, wherein
the spacer density in a boundary region between the first curved region and the second region is larger than that in the second region except for the boundary with any other region.

5. A liquid crystal display element according to claim 3, wherein
the second region is a second curved region or a flat region.

6. A liquid crystal display element according to claim 1, wherein
each of the substrates is a polymer film substrate.

7. A liquid crystal display element comprising:
a pair of substrates;
a liquid crystal disposed between the substrates;
a plurality of resin structures disposed between the substrates and adhered to the substrates; and
a sealing wall disposed between the substrates and surrounding the liquid crystal, wherein
the substrates are opposed to each other such that a major surface of the liquid crystal display element has a non-flat form, and
a resin structure adhesion area, per unit area of the substrate, with respect to the substrate in a predetermined region of the liquid crystal display element is different from that in at least a portion of the other region.

8. A liquid crystal display element according to claim 7, wherein
the liquid crystal display element has a plurality of regions having different curvatures, and
the resin structure adhesion area, per unit area of the substrate, with respect to the substrate in the region of a large curvature is larger than that in the region of a small curvature.

9. A liquid crystal display element according to claim 7, wherein
at least one of a form of the resin structure, a size of the resin structure and an arrangement pitch of the resin structures is different between regions of the liquid crystal display element, the regions having different resin structure adhesion areas, per unit area of the substrate, with respect to the substrate.

10. A liquid crystal display element according to claim 7, wherein
the liquid crystal display element has a first curved region and a second region neighboring the first curved region and having a smaller curvature than the first curved region, and
the resin structure adhesion area, per unit area of the substrate, with respect to the substrate in the first curved region except for a boundary with any other region is larger than that in the second region except for a boundary with any other region.

11. A liquid crystal display element according to claim 10, wherein
the resin structure adhesion area, per unit area of the substrate, with respect to the substrate in a boundary region between the first curved region and the second region is different from that in the second region except for the boundary with any other region.

12. A liquid crystal display element according to claim 10, wherein
the second region is a second curved region or a flat region.

13. A liquid crystal display element according to claim 7, wherein
each of the substrates is a polymer film substrate.

14. A liquid crystal display element comprising:
a pair of substrates;
a liquid crystal disposed between the substrates; and
a sealing wall disposed between the substrates and surrounding the liquid crystal, wherein
the substrates are opposed to each other such that a major surface of the liquid crystal display element has a non-flat form, and
at least one of a pixel form, a pixel size and a pixel arrangement pitch in a predetermined region of the liquid crystal display element is different from that in at least a portion of the other region.

15. A liquid crystal display element according to claim 14, wherein
at least one of the pixel form, the pixel size and the pixel arrangement pitch is different between regions of the liquid crystal display element so that at least corresponding one of the pixel form, the pixel size and the pixel arrangement pitch in all the regions of the liquid crystal display element appears same or substantially same when viewed from a predetermined observation direction.

16. A liquid crystal display element according to claim 14, wherein
the liquid crystal display element has a first region and a second region, and
the first and second regions are first and second flat regions, respectively, having normals in different directions.

17. A liquid crystal display element according to claim 14, wherein
the liquid crystal display element has a first region and a second region, and
the first and second regions are first and second curved regions, respectively, having different curvatures.

18. A liquid crystal display element according to claim 14, wherein
the liquid crystal display element has a first region and a second region, and
the first region is a curved region, and the second region is a flat region.

19. A liquid crystal display element according to claim 14, wherein
the liquid crystal display element entirely has a curved form of a single curvature.

20. A liquid crystal display element according to claim 14, wherein
each of the substrates is a polymer film substrate.

21. A liquid crystal display element comprising:
a pair of substrates;
a liquid crystal disposed between the substrates;
a plurality of resin structures disposed between the substrates; and
a sealing wall disposed between the substrates and surrounding the liquid crystal, wherein
the substrates are opposed to each other such that a major surface of the liquid crystal display element has a non-flat form, and
at least one of a form of the resin structure, a size of the resin structure and an arrangement pitch of the resin structures in a predetermined region of the liquid crystal display element is different from that in at least a portion of the other region.

22. A liquid crystal display element according to claim 21, wherein
at least one of the form of the resin structure, the size of the resin structure and the arrangement pitch of the resin structures is different between regions of the liquid crystal display element so that at least corresponding one of the form of the resin structure, the size of the resin structure and the arrangement pitch of the resin structures in all the regions of the liquid crystal display element appears same or substantially same when viewed from a predetermined observation direction.

23. A liquid crystal display element according to claim 21, wherein
the liquid crystal display element has a first region and a second region, and
the first and second regions are first and second flat regions, respectively, having normals in different directions.

24. A liquid crystal display element according to claim 21, wherein
the liquid crystal display element has a first region and a second region, and
the first and second regions are first and second curved regions, respectively, having different curvatures.

25. A liquid crystal display element according to claim 21, wherein
the liquid crystal display element has a first region and a second region, and
the first region is a curved region, and the second region is a flat region.

26. A liquid crystal display element according to claim 21, wherein
the liquid crystal display element entirely has a curved form of a single curvature.

27. A liquid crystal display element according to claim 21, wherein
each of the substrates is a polymer film substrate.

28. A method of producing a liquid crystal display element comprising the steps of:
disposing spacers on at least one of paired flat substrates such that a spacer density in a predetermined region of the flat substrate is different from that in at least a portion of the other region;
holding a liquid crystal between the paired flat substrates carrying the spacers, and closing the substrates at a periphery of the liquid crystal by a sealing wall to produce a flat liquid crystal display element having an entirely flat form; and
deforming the flat liquid crystal display element into a predetermined non-flat form.

29. A producing method according to claim 28, wherein
at least a portion of the flat liquid crystal display element is curved in the deforming step.

30. A producing method according to claim 28, wherein
each of the substrates is a polymer film substrate.

31. A method of producing a liquid crystal display element comprising the steps of:
disposing resin structures on at least one of paired flat substrates such that a resin structure adhesion area, per unit area of the substrate, with respect to the substrate in a predetermined region of the flat substrate is different from that in at least a portion of the other region;
holding a liquid crystal between the paired flat substrates carrying the resin structures, and closing the substrates at a periphery of the liquid crystal by a sealing wall to produce a flat liquid crystal display element having an entirely flat form; and
deforming the flat liquid crystal display element into a predetermined non-flat form.

32. A producing method according to claim 31, wherein
at least a portion of the flat liquid crystal display element is curved in the deforming step.

33. A producing method according to claim 31, wherein
each of the substrates is a polymer film substrate.

34. A method of producing a liquid crystal display element comprising the steps of:
forming at least one electrode on each of paired flat substrates such that at least one of a pixel form, a pixel size and a pixel arrangement pitch in a predetermined region is different from that in at least a portion of the other region;
holding a liquid crystal between the paired flat substrates carrying the electrodes, and closing the substrates at a periphery of the liquid crystal by a sealing wall to produce a flat liquid crystal display element having an entirely flat form; and
deforming the flat liquid crystal display element into a predetermined non-flat form.

35. A producing method according to claim 34, wherein
at least a portion of the flat liquid crystal display element is curved in the deforming step.

36. A producing method according to claim 34, wherein
each of the substrates is a polymer film substrate.

37. A method of producing a liquid crystal display element comprising the steps of:
forming resin structures on at least one of paired flat substrates such that at least one of a form of the resin structure, a size of the resin structure and an arrangement pitch of the resin structures in a predetermined region of the flat substrate is different from that in at least a portion of the other region;
holding a liquid crystal between the paired flat substrates carrying the resin structures, and closing the substrates at a periphery of the liquid crystal by a sealing wall to produce a flat liquid crystal display element having an entirely flat form; and
deforming the flat liquid crystal display element into a predetermined non-flat form.

38. A producing method according to claim 37, wherein
at least a portion of the flat liquid crystal display element is curved in the deforming step.

39. A producing method according to claim 37, wherein
each of the substrates is a polymer film substrate.
